(19) United States
(12) Patent Application Publication
(10) Pub. No.: US 2014/0304177 A1
(43) Pub. Date: Oct. 9, 2014

(54) SYSTEM AND METHOD FOR DIGITAL RIGHTS MANAGEMENT USING ADVANCED COPY WITH ISSUE RIGHTS, AND MANAGED COPY TOKENS

(71) Applicant: ContentGuard Holdings, Inc., Plano, TX (US)

(72) Inventors: Thomas Michael DeMartini, Culver City, CA (US); Michael Charles Raley, Downey, CA (US); Xin Wang, Rancho Palos Verdes, CA (US); Joseph Zhung-Yee Fung, Cerritos, CA (US); Mai Nguyen, Buena Park, CA (US); Guillermo Lao, Torrance, CA (US); Rajan Samtani, Agoura Hills, CA (US); Eddie Jen-Shien Chen, Rancho Palos Verdes, CA (US); Kerry Philip Miller, Hermosa Beach, CA (US)

(73) Assignee: ContentGuard Holdings, Inc., Plano, TX (US)

(21) Appl. No.: 14/257,982

(22) Filed: Apr. 21, 2014

Related U.S. Application Data
(63) Continuation of application No. 11/528,680, filed on Sep. 28, 2006, now abandoned.
(60) Provisional application No. 60/721,523, filed on Sep. 29, 2005.

(51) Int. Cl. G06Q 10/06; G06Q 50/18

(52) U.S. Cl. CPC G06Q 10/06; G06Q 50/184
USPC 705/310

(57) ABSTRACT

A system, method and computer program product for a digital content player having a DRM agent to perform rights management operations on a digital content package, including loading rights management instructions to be executed by the digital content player, the rights management instructions being associated with the digital content package, executing the rights management instructions on the digital content player, and loading supporting licenses associated with the digital content package for processing by the DRM agent. The DRM agent deciding whether to permit the rights management operations requested by the rights management instructions. Further exemplary embodiments include systems, methods and computer program products for associating usage rights with digital content packages, managing of digital rights tokens, managing of digital content packages having predetermined broadcast dates, preserving of usage rights when content is transferred between DRM environments, and distributing content packages.

### CROSS REFERENCE TO RELATED DOCUMENTS

This application is a Continuation of application Ser. No. 11/528,680, filed on Sep. 28, 2006 (now pending), which claims priority to U.S. Provisional Patent Application Ser. No. 60/721,523 of DeMartini, entitled “ADVANCE COPY WITH ISSUE RIGHTS,” filed Sep. 29, 2005 (now expired), the disclosures of which are incorporated by reference of their entireties.

### BACKGROUND OF THE INVENTION

1. Field of the Invention

The present invention generally relates to Digital Rights Management (DRM) system and methods, and more particularly, to a method and system for Digital Rights Management, for example, using advanced copy with issue rights, managed copy tokens, and the like.

2. Discussion of the Background

In recent years, systems have been developed to address various aspects of Digital Rights Management (DRM). However, many of these prior art systems lack robust mechanisms for handling digital rights management instructions, associating usage rights with digital content packages, managing of digital rights tokens, managing of digital content packages having predetermined broadcast dates, preserving of usage rights when content is transferred between DRM environments, and distributing content packages.

### SUMMARY OF THE INVENTION

Therefore, there is a need for a method and system that addresses the above and other problems. The above and other problems are addressed by the exemplary embodiments of the present invention, which provide a method and system for Digital Rights Management, for example, using advanced copy with issue rights, managed copy tokens, and the like. Advantageously, the exemplary embodiments provide robust mechanisms for handling digital rights management instructions, associating usage rights with digital content packages, managing of digital rights tokens, managing of digital content packages having predetermined broadcast dates, preserving of usage rights when content is transferred between DRM environments, distributing content packages, and the like.

Accordingly, in exemplary aspects of the present invention there is provided a system, method, and computer program product for a digital content player having a DRM agent to perform rights management operations on a digital content package, including loading rights management instructions to be executed by the digital content player, the rights management instructions being associated with the digital content package, executing the rights management instructions on the digital content player, and loading supporting licenses associated with the digital content package for processing by the DRM agent. The DRM agent deciding whether to permit the rights management operations requested by the rights management instructions.

In further exemplary aspects of the present invention there is provided a system, method, and computer program product for providing usage rights for digital content, including associating with a digital content package a set of usage rights, recording the digital content package onto an original recording medium, and providing for legitimate copies to be made of the digital content package onto a user-recording medium and for the usage rights to be associate with the legitimate copies. The usage rights including first and second provisions. The first provision pertaining to rights to be provided only in the presence of the original recording medium. The second provision pertaining to rights to be provided in the absence or presence of the original recording medium.

In further exemplary aspects of the present invention there is provided a system, method, and computer program product for a digital content player adapted to play digital content packages in accordance with usage rights, including a renderer for rendering digital content packages, a token repository for storing, creating and transferring tokens based upon token management rights from a corresponding token issuer, and a DRM agent coupled to the token repository and the renderer for interpreting and enforcing usage rights associated with a digital content package and for communicating with the token repository to verify the possession of a token with a specific identifier if the usage rights require the possession of a token with the specific identifier.

In further exemplary aspects of the present invention there is provided a system, method, and computer program product for an original recording medium, including a recording of a digital content package having a pre-determined broadcast date, and a set of usage rights for the digital content package. The usage rights not allowing the digital content package to be viewed before the pre-determined broadcast date.

In further exemplary aspects of the present invention there is provided a system, method, and computer program product for preserving usage rights when content is transferred between DRM environments, including assigning a first set of usage rights to a digital content package, the first set of usage rights being adapted for enforcement in a first DRM environment, transferring the digital content package to a second DRM environment, translating the first set of usage rights into a second set of usage rights that are adapted for enforcement in the second DRM environment, associating the second set of usage rights with the digital content package, and maintaining the association of the first set of usage rights with the digital content package.

In further exemplary aspects of the present invention there is provided a system, method, and computer program product for distributing a digital content package, including associating a set of usage rights with a digital content package, and associating a set of meta-rights with the digital content package, the meta-rights defining rights to be issued to allowed modifications of the digital content package.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary Digital Rights Management (DRM) system;

FIG. 2 illustrates an exemplary flow for taking direction;

FIG. 3 illustrates exemplary content;

FIG. 4 illustrates exemplary usage rights transfers;

FIG. 5 illustrates an exemplary flow for processing rights-managed actions, such as play, copy, and issue;

FIG. 6 illustrates an exemplary repository, including a token repository, a token, and a token identifier;

FIG. 7 illustrates exemplary media, including token rights, content, and usage rights;

FIG. 8 illustrates an exemplary token file system;

FIG. 9 illustrates an exemplary database;

FIG. 10 illustrates an exemplary token identifier grammar;

FIG. 11 illustrates exemplary token transfers;

FIG. 12 illustrates an exemplary flow for utilizing Managed Copy Tokens (MCTs);

FIG. 13 illustrates an exemplary flow detailing how the exemplary DRM system determines if conditions are satisfied;

FIG. 14 illustrates an exemplary flow detailing content distribution;

FIG. 15 illustrates a further exemplary DRM system for content distribution;

FIGS. 16-17 illustrate prior art usage rights processing;

FIGS. 18-20 illustrate prior art usage rights processing, according to the exemplary embodiments;

FIG. 21 illustrates how usage rights can be associated with modified content, according to the exemplary embodiments;

FIG. 22 illustrates an exemplary license;

FIGS. 23-27 illustrate exemplary usage rights elements, according to the exemplary embodiments; and

FIGS. 28-29 illustrate a further exemplary DRM system.

### DETAILED DESCRIPTION OF THE PREFERRED EMBODIMENTS

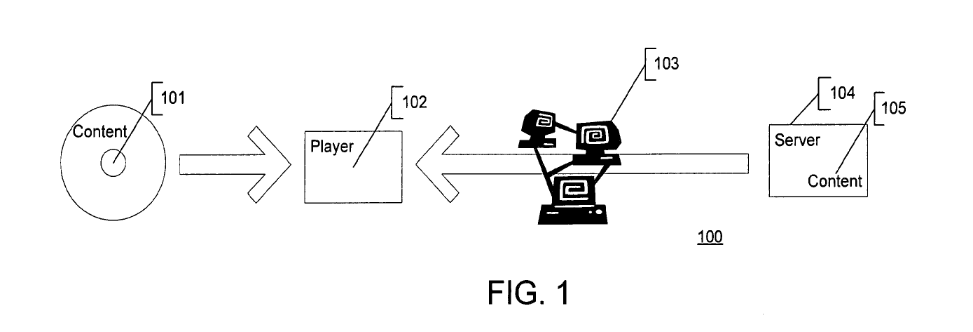

Referring now to the drawings, wherein like reference numerals designate identical or corresponding parts throughout the several views, and more particularly to FIG. 1 thereof, there is illustrated an exemplary Digital Rights Management system 100, according to an exemplary embodiment. In FIG. 1, content (101, 105) is fed into a content playing apparatus (102) from a disk (101) or from a server (104) via a network (103). The content (300) can include a variety of content types including but not limited to one or more of audio or video media files (301, 302), executable code (303, 304), rights (305, 306), and metadata. The content playing apparatus (102) (“player” for short) can be a hardware device, or a software or firmware implementation.

Two possible functions of the player are considered: the ability to make a copy of the content and the ability to issue rights. Some players might have either of the functions and some might have both. In one embodiment, the player can perform either or both of these functions under predetermined situations, such as immediately when a content disk is placed in the player's drive. In another embodiment, the player can have one or more buttons or other user interface elements on the player hardware, remote control, and/or attached monitor and mouse that can be utilized by the user of the player to cause the player to perform either or both of these functions. In a third embodiment, the player can have another function to present parts of the content to the user in an interactive way and the interactive components of the content can direct the player to perform either or both of the function of making a copy of the content or issuing rights. In another embodiment, the player can read instructions from the content as to when to perform either or both of the functions. In still further embodiments, the player can combine aspects of these different embodiments; for example, the player might have a hardware button to determine when to perform copies and might utilize the interactive features of the content to determine when to issue rights and what rights to issue.

As used in the context of the present patent application, the term “rights management instructions” refers to instructions for rights management operations such as issuing rights to or for the copying of digital content. Such instructions might include instructions as to when such digital content is to be copied or what portion of said digital content is to be copied or where such digital content is to be copied to. Similarly, such instruction might direct what rights are to be issued, when they are to be issued, what portion(s) of the content that they are to apply to and whom they are to be issued to. Such instructions, however, do not simply direct the playing of digital content.

As used herein, a “DRM agent” is a collection of software and/or hardware which serves to identify and enforce usage rights associated with digital content.

A digital content package, as used herein, refers to an audio event (such as a song or album), a video event (such as a home movie or an animation), an audio-visual event (such as a movie, television show, music video and the like), a digital image, digital textual information, or any other defined amount of digital information to be presented to a user including portions thereof and combinations thereof.

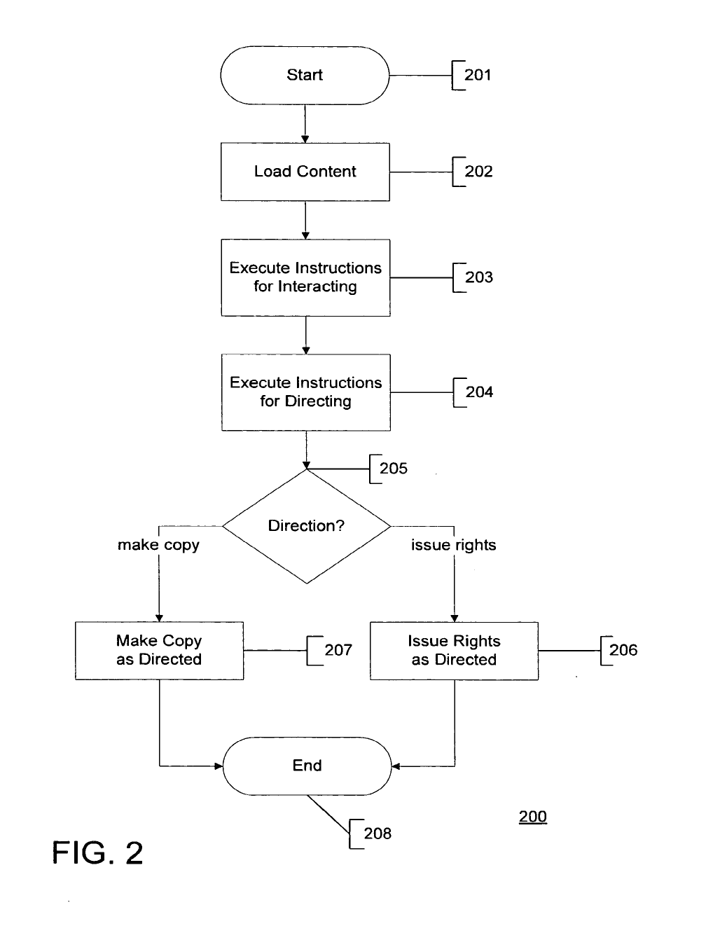

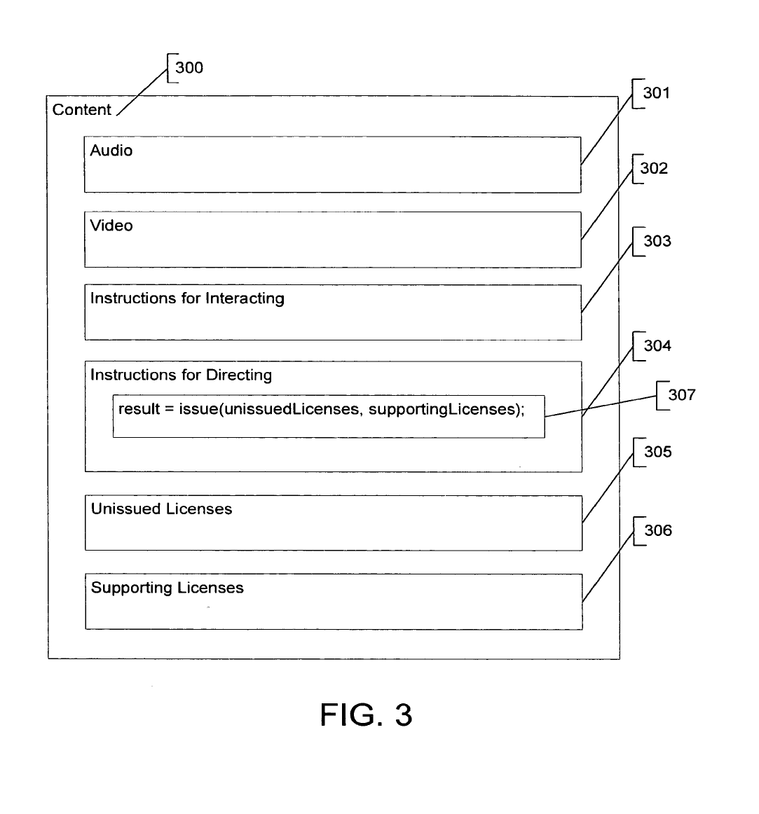

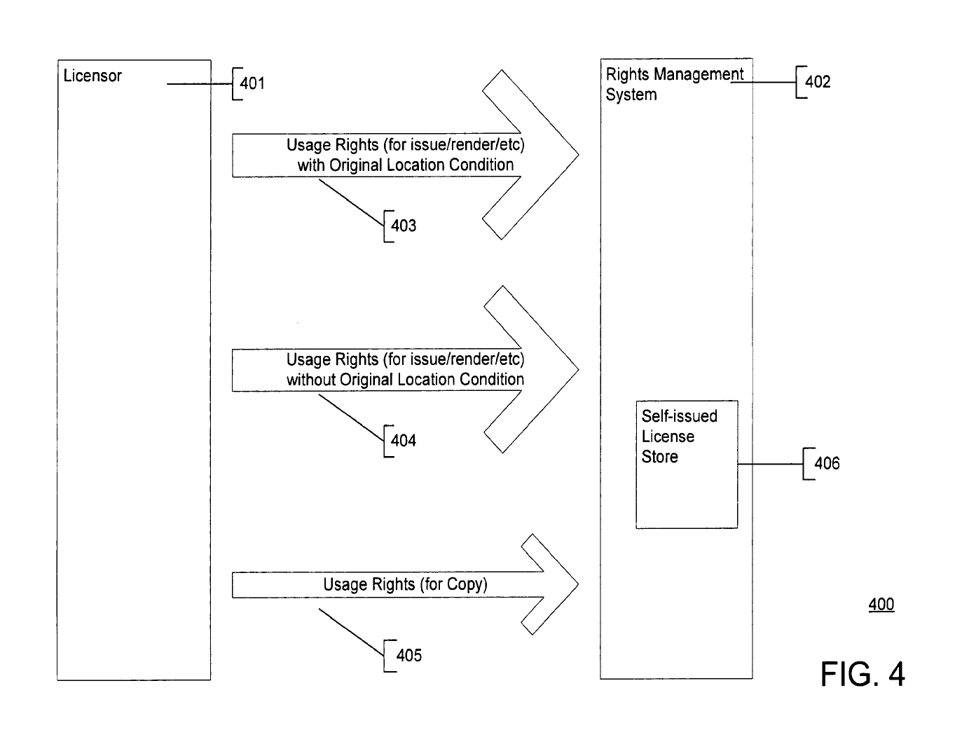

FIG. 2 shows an example flow for taking direction. The flow starts at step 201. In step 202 the player loads the content 300. In step 203 the player executes the instructions for interacting 303. Pursuant to user interaction, the instructions for interacting result in the player executing in step 204 instructions for directing 304 using specific instructions 307 in a defined API. Based on this API call, the player will understand the direction in step 205. If the direction is to issue rights, the player will issue rights as directed in step 206. If the direction is to make a copy, the player will make a copy as directed in step 207. The flow is finished at step 208.

An example API for allowing the interactive features of the content to direct the player to issue rights is shown in 307 as “result=issue(unissuedLicense, supportingLicenses)”. The unissuedLicense parameter is an unissued License that the interactive features of the content are asking the player to issue. The unissuedLicense can be passed directly to the function or it can be passed by reference, such as by URI. The supportingLicenses parameter is all the issued Licenses that authorize the player to issue the unissuedLicense. The supportingLicenses parameter can be passed directly to the function or it can be passed by reference, such as by URI. The supporting Licenses can also be determined by the player based on other conventions. For example, the player can know how to look up supporting Licenses from elsewhere in the content or from other sources. The result return value is used to inform the interactive features of the content whether the issuance of the license was successful or not and possibly why.

When issuing rights (515), the player first checks if it is authorized to issue those rights (510). This check is performed against the supporting Licenses (503, 505, 509). In one embodiment, the supporting Licenses are found in a title usage file (TUF) (505), which is a file of usage rights that is cryptographically bound to some content and authenticated by some trusted entity to make verification (507) of those Licenses possible. In a further aspect of the embodiment, the cryptographic binding can further associate the content with a content provider identification, and the identified content provider can serve as the trusted root issuer for performing an REL authorization request for the player to issue rights. In other words, it could be further checked (507) that the supporting Licenses are authorized by the content provider identified associated with the content associated with the TUF including the supporting Licenses.

Once the player issues rights (515), in one embodiment the player can sign the License including those rights. In another embodiment, the player can store the License in a secure fashion (515) and record information about its issuance of that License, such as the authorization request (510) it made when determining if it was authorized to issue that license. By keeping this record, the player has the information in needs to know whether it is appropriate to use the r:issueContext and r:issueTime properties defined in the REL standard (ISO/IEC 21000-5:2004) for future authorization requests (502) (for example, future authorization requests to play the content or copy the content). For optimization purposes, it is possible to reduce the amount of information recorded by the player. For example, the player need not necessarily remember the time at which it issued the License if it makes no retrospective queries and handles all authorization-related flows in a time-liner fashion. In the extreme case, it is possible for the player to keep no record other than that those Licenses stored in the prescribed secure fashion (406) have all been properly issued.

Usage rights can be associated with a digital content package in various ways. For example the two can be associated by being recorded to the same recording medium. Alternatively, an identification code associated with digital content package can be used to access via a communications link the associated rights.

As used herein, a legitimate copy refers to a copy that is permitted in accordance with the governing usage rights. It is not meant to cover copies made by hacking, reverse engineering, or other unauthorized methods.

As used herein the term original recording medium is used to refer to a recording medium distributed by the content owner and its authorized representatives. This is to be contrasted with a user recording medium which refers to a copy made by an end-user. In the present invention, a user-recording medium may be a digital content player with a hard drive or other storage medium to which content can be recorded.

In accordance with the present invention two sets or provisions of rights are provided. In the first instance there is a superset of rights that is allowed in the presence of the original recording medium. For example, if the original recording medium is an HD-DVD, a copy of that HD-DVD is made onto a user's HD-DVD player, or computer, the user will be afforded greater rights while the HD-DVD is in the player or computer and lesser rights when it is not. One example of rights could be the right to make additional copies. That right might only be granted in the presence of the original HD-DVD in the player or computer. In that way a user could loan the HD-DVD to a friend who could make a recording on the friend's player or computer. Once the friend returned the HD-DVD to its owner, that friend could watch the digital content package but could not make additional copies. Another example would be a promotion that would allow copies of the original to be viewed only during a given time-based window whereas the original HD-DVD, or for that matter, a copy of the digital content package from the HD-DVD when the original HD-DVD is in the same player or computer as the copy, could be viewed in a different and most likely larger time-based window.

In another embodiment of this invention, meta-rights on the original recording medium can be used to issue further rights beyond those originally associated with the digital content package. These further usage rights would be usable with the original recording medium, user recording mediums, and any other copy of the digital content package, just as if they had been originally associated with the digital content package. Meta-rights provide the flexibility to base usage rights on events that occur after the original usage rights are associated with the digital content package. For example, meta-rights can make it possible to put usage rights into effect that are valid for a particular digital content player that has physically interacted with the original recording medium. The identity of the digital content player cannot be known ahead of time; however the meta-rights can permit the digital content player to issue usage rights to itself so as to allow it to use any copy of the digital content package even after the original recording medium has been removed.

In order to authenticate these further usage rights, it is necessary to secure them. A digital content player can have a secure storage for the purpose. In one embodiment, the secure storage can be configured such that only the digital content player operating according to authorized meta-rights can write to the storage. In another embodiment, the secure storage can be configured such that the digital content player can only read rights it has written to the storage while operating according to authorized meta-rights. In either case, after the digital content player reads usage rights from its secure storage, it can be confident that they are authentic usage rights, duly issued under meta-rights from the content owner of the digital content package or its authorized representatives.

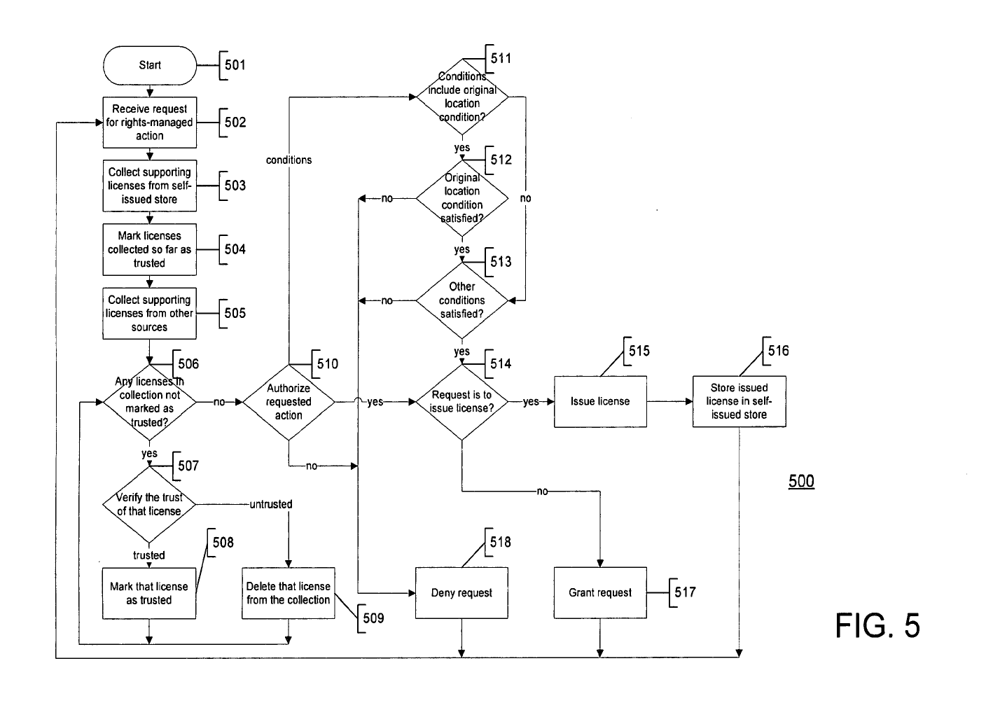

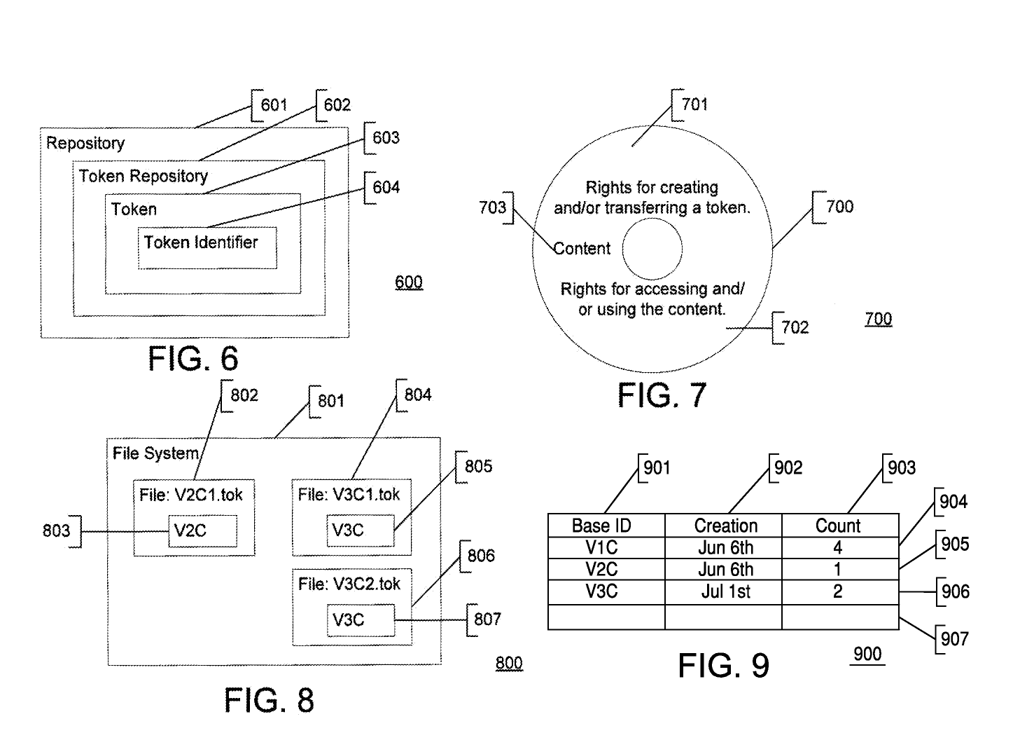

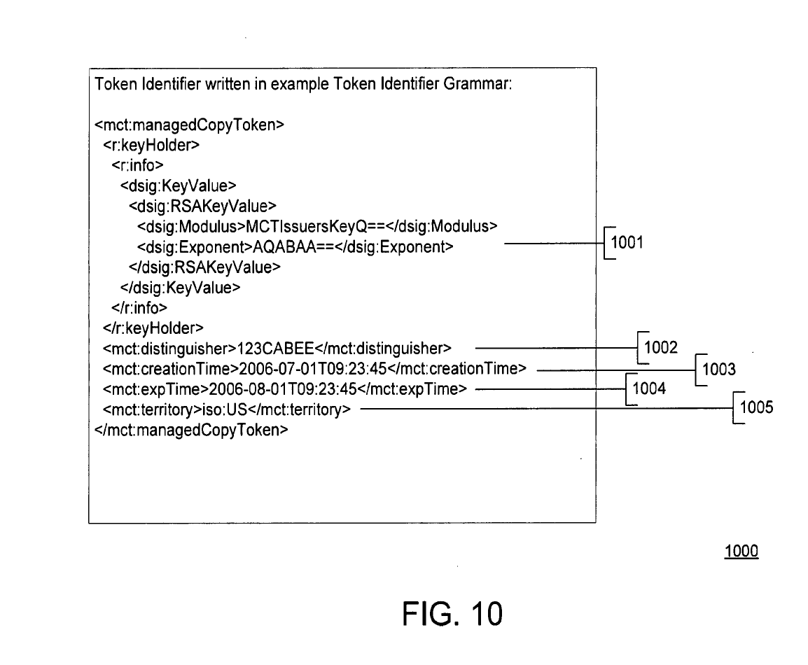

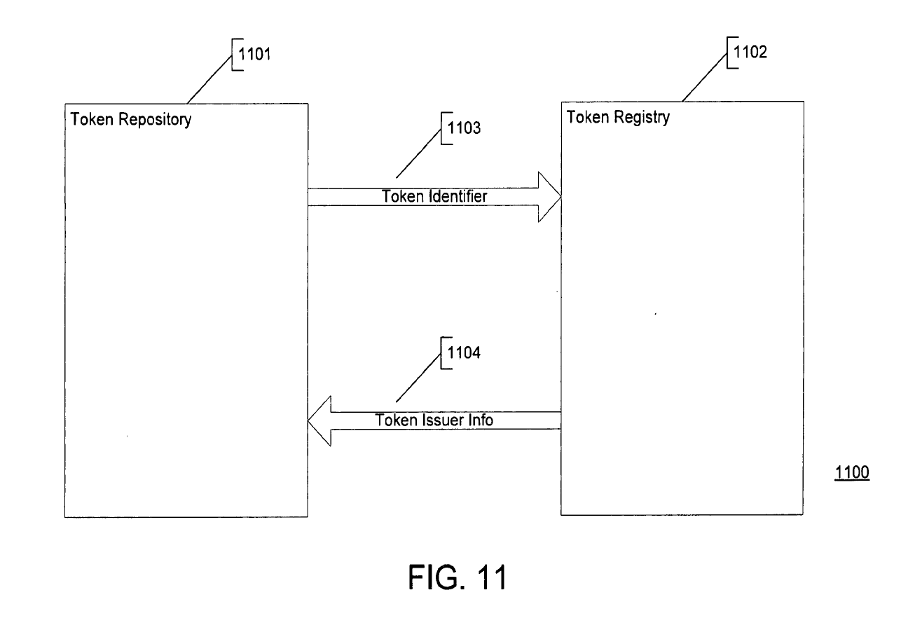

FIG. 5 shows an example flow for processing rights-managed actions, such as play, copy, and issue. The flow starts at step 501. A request to perform an action is received at step 502. Previously-self-issued licenses can be collected out of the self-issued license store (406) at step 503. If the self-issued license store was secured, all the licenses collected so far can be marked as trusted in step 504. In step 505, additional licenses can be collected. If a self-issued license store is not secure, those licenses can be collected in this step. Licenses from a licensor, from other parties, and from the disk can also be collected. In step 506, a determination is made whether all the licenses are trusted. If not, step 507 is performed for each such untrusted license. The verification process can include validating metadata about the storage of the license, validating a signature on the license, matching the signer of the license to the content owner (perhaps by looking up the content owner in the TUF), or even running an entire authorization algorithm such as the one defined in XrML 2.0. If the license is found to be trusted at step 507, it is marked as trusted in step 508 and flow passes back to step 506 to proceed with the next license or detect that all licenses have been verified trusted. If the license is found to be untrusted at step 507, the license is deleted from the collection at step 509 and flow passes back to step 506 to proceed with the next license or detect that all remaining licenses have been verified trusted.

Once all remaining licenses have been verified trusted in step 506, an attempt is made in step 510 to authorize the action requested in step 502. The authorization can result in no, yes, or conditions. If the authorization results as no, the request is denied in step 518 and the next request is processed in step 502. If the authorization results in conditions, flow proceeds to step 511, 512, and 513. If any of the conditions are not satisfied, the request is denied in step 518. If all conditions are satisfied or if the authorization originally resulted in yes, flow proceeds to step 514, where the nature of the request is determined. If the request is to play or copy, it is granted at step 517 and the next request is processed in step 502. If, on the other hand, the request is to issue rights, the license is issued in step 515, including signing the license if signing is necessary. At step 516 the license is stored in the self-issued license store 406 for later retrieval in step 503 (in case 406 represents secure storage) or step 505 (in case 406 represents insecure storage).

The process described in FIG. 5 is an exemplary process to demonstrate one example of how such a process might take place. A person skilled in the art would recognize that many variations of it are possible, that the steps can be performed in different orders, that results can be cached, and that the process can be performed in parallel or in another relationship with other processes occurring in the player.

By utilizing the issue rights feature of the player to cause the player to issue rights specific to the particular player or to other particular devices, it is possible to accomplish interesting models for the distribution and use of content. For example, one manner of use might be permitted for all parties (broad rights) (403, 404, 405), while another manner of use might be permitted for specific players (rights stored in 406).

By utilizing the copy feature of the player to copy content from its original location into other locations without changing the content identifier, it is possible to accomplish interesting models for the distribution and use of content. For example, one manner of use might be permitted for content available from its original location (403), while another manner of use might be permitted for the same content regardless of its location (404).

By the combined utilization of the issue rights and copy features of the player, even more interesting models for the distribution and use of content can be accomplished. For example, one manner of use might apply to all players and regardless of content location (404); another manner of use might apply to all players with the content available from its original location (403); another manner of use might apply to specific players regardless of content location (some rights in 406); and another manner of use might apply to specific players with content available from its original location (other rights in 406). The following example describes a scenario utilizing three of these manners of use.

### Example

A content provider (401) makes content (300) available on a read-only optical disk (101) (the original location). For promotion purposes, the content can be played by anyone on Dec. 1, 2005, whether or not they have the original optical disk (using rights 404). The content can also be played by anyone who has the optical disk at any time (using rights 403). A consumer borrows the disk from a friend. There is a copy creation offer (405) that allows the consumer to create a copy for free. Of course, this copy would only be playable on Dec. 1, 2005, (pursuant to 404) unless the disk is present (pursuant to 403). The content usage rules 403 also permit the issuance of new usage rules (406) in the presence of the disk to allow the same player to play the content for up to one day without the presence of the disk (so he can return the disk to his friend right away, and still play the copy for a day).

Five grants are involved in this scenario:
1. A grant to allow anyone to make a copy of the content for free. (405)
2. A grant to allow anyone to play the content on Dec. 1, 2005, whether or not they have the original optical disk. (404)
3. A grant to allow anyone to play the content in the presence of the disk regardless of the day. (403)
4. A grant to allow anyone to designate, in the presence of the disk, that same player (the one having the disk) as being able to play the content without the presence of the disk for up to one day. (403)
5. A grant to allow a particular player (designated in #4) to play the content without the presence of the disk for up to one day. (406)

The first four grants are issued by the content provider and shipped on the disk (at 306) and copied along with the advanced copy. The fifth grant is issued by the player at the direction of the interactive features (303, 304) of the content calling the issue( ) API (307) and is stored (406) on the device (402).

The first grant is shown in the following License:

<r:license>
<r:grant>

<bpx:governedCopy governanceRule=“new:copy”/>
<r:digitalResource>
<r:nonSecureIndirectURI=“urn:provider:theMovie”/>
</r:digitalResource>

```
  </r:grant>
  <r:issuer>
```

<bpx:identityHolder
idSystem=“http://www.ids.org/sys1”>A35D</bpx:identityHolder>

</r:issuer>
</r:license>

The second, third, and fourth grants are shown in the following License:

```
<r:license>
  <r:grant>
    <mx:play/>
    <r:digitalResource>
      <r:nonSecureIndirect URI=“http://www.ids.org/
      sys2/A35D00000001/999”/>
    </r:digitalResource>
    <bpx:startCondition>
      <r:validityInterval>
        <r:notBefore>2005-12-01T00:00:00</r:notBefore>
        <r:notAfter>2005-12-02T00:00:00</r:notAfter>
      </r:validityInterval>
    </bpx:startCondition>
  </r:grant>
  <r:grant>
    <mx:play/>
    <r:digitalResource>
      <r:nonSecureIndirect URI=“http://www.ids.org/
      sys2/A35D00000001/999”/>
    </r:digitalResource>
    <phys:diskInDrive>
      <phys:volumeId>HLmRlad8M7jldhbK0pXQ==
      </phys:volumeId>
    </phys:diskInDrive>
  </r:grant>
  <r:grant>
    <r:forAll varName=“oneDevice”>
      <bpx:identityHolderPattern idSystem=
      “http://www.ids.org/sys1”/>
    </r:forAll>
    <r:forAll varName=“oneDay”>
      <sx:validityIntervalDurationPattern>
        <sx:duration>P1D</sx:duration>
      </sx:validityIntervalDurationPattern>
    </r:forAll>
    <bpx:identityHolder varRef=“oneDevice”/>
    <r:issue/>
    <r:grant>
      <bpx:identityHolder varRef=“oneDevice”/>
      <mx:play/>
      <r:digitalResource>
        <r:nonSecureIndirect URI=“http://www.ids.org/
        sys2/A35D00000001/999”/>
      </r:digitalResource>
      <bpx:startCondition>
        <r:validityInterval varRef=“oneDay”/>
      </bpx:startCondition>
    </r:grant>
    <sx:validityIntervalStartsNow>
      <r:validityInterval varRef=“oneDay”/>
    </sx:validityIntervalStartsNow>
  </r:grant>
  <r:issuer>
    <bpx:identityHolder idSystem=“http://www.ids.org/
    sys1”>A35D</bpx:identityHolder>
  </r:issuer>
</r:license>
```

The fifth grant is shown in the following License:

```
<r:license>
  <r:grant>
    <bpx:identityHolder
idSystem=“http://www.ids.org/sys3”>
ad8UJQ7jHLmR110pXdhbKQ==</bpx:identityHolder>
    <mx:play/>
    <r:digitalResource>
      <r:nonSecureIndirect URI=“http://www.ids.org/
      sys2/A35D00000001/999”/>
    </r:digitalResource>
    <bpx:startCondition>
      <r:validityInterval>
        <r:notBefore>2005-12-05T19:03:02</r:notBefore>
        <r:notAfter>2005-12-06T19:03:02</r:notAfter>
      </r:validityInterval>
    </bpx:startCondition>
  </r:grant>
  <r:issuer>
    <bpx:identityHolder
idSystem=“http://www.ids.org/sys3”>
ad8UJQ7jHLmR110pXdhbKQ==</bpx:identityHolder>
  </r:issuer>
</r:license>
```

The above described exemplary embodiments, advantageously, determine when to issue rights in a user-friendly way, accomplish a perception of different rights to copies, and establish trust for and secure licenses issued by players.

Further exemplary embodiments employ the use of Managed Copy Tokens (MCTs) to simulate virtual copies. Every MCT (603) has a token identifier (604). The token identifier (604, 805, 807) can be shared by multiple tokens (603, 804, 806), so, for example, there can be 3 MCTs with token identifier ABC. In one exemplary embodiment, the token identifier can be written in a token identifier grammar. An example token identifier grammar is that the token identifier includes the token issuer's public key (1001) followed by a token issuer-assigned token distinguisher (1002). Such a grammar would allow, for example, the easy determination of the token issuer associated with any MCT. The token issuer is the entity that is authorized to issue licenses (701) allowing for the creation and transfer of that MCT. In another example token identifier grammar, the token identifier includes a number of fields indicating different classes to which the token belongs. Such a grammar would allow, for example, the easy determination of the token classes associated with any MCT and the easy construction of rights expressions which allow the creation, transfer, or use of tokens from a certain class.

Creation and transfer of MCTs are governed by the MCT issuer. Systems require some way to determine the MCT issuer for any given MCT. One example way is by using a token identifier grammar such as defined above with a field (1001) for the token issuer. Another way is to have a MCT registry (1102) wherein the MCT issuer can be looked up by a token repository 1101 sending a request 1103 with a token identifier and receiving a response 1104 with the token issuer info. In one example, an MCT issuer might allow (for example, via usage rights 701) an MCT with identifier “ABC” to be created by Canadians for the payment of $5. If 10 Canadians each pay $5, then there will be 10 MCTs created with identifier “ABC”. If an 11^{th} Canadian pays $10, he can create two more MCTs. Further expanding upon this example, consider that the MCT issuer authorizes (for example, via usage rights 701) the tokens to be transferred to any other Canadian or US Citizen. The 10^{th} Canadian could then transfer his token to a US Citizen and the 11^{th} Canadian could transfer one of his tokens, for example, to the 10^{th} Canadian. The 11 Canadians and 1 US Citizen would then have one token each.

MCTs are typically created, transferred, and managed by some trusted software or hardware (602) such that indiscriminate creation and transfer of tokens is not possible or is distinguishable from the legitimate creation and transfer of tokens. The small size of MCTs relative to digital content makes them ideally suited for management by trusted software or hardware designed to be immune to backup-and-recovery attacks. MCTs can be represented in a number of ways such as files (802, 804, 806) in a file system (801) or entries in a database (900). In one example, a trusted database (900) includes an MCT table with two sets of columns, one for MCT identifier (901, 902 or just 901) and one for MCT count (903). Each row in the database (904, 905, 906, 907) represents the corresponding count of MCTs with the corresponding identifier. When an MCT is created, the count is increased. When an MCT is transferred, the count is decreased on the sending side and increased on the receiving side.

In order to simulate virtual copies, usage rights (702) to content (703) can be conditioned upon the possession of certain MCTs that have been legitimately created and/or transferred. For example, in the example above with 11 Canadians and 1 US Citizen, if the right (702) to view an e-book (703) was conditioned upon the possession of an MCT with token identifier “ABC”, then the transferring of MCT occurring between the US Citizen and 10^{th} and 11^{th} Canadians would be simulating the transferring of the associated book between them because whoever holds the MCT can view the e-book (just like whoever holds a physical copy of a book can read the book).

In addition to having usage rights to content conditioned upon the possession of certain MCTs, it is also possible to have some usage rights to content conditioned upon the possession of a first type of MCTs, other usage rights to the same content conditioned upon the possession of a second type of MCTs, still other usage rights to the same content conditioned upon the possession of some physical media, and still other usage rights to the same content unconditioned upon either the first or second type of MCTs or media. If the MCT creation rights for the first type of MCT are conditioned upon possession of the second type of MCT and if the MCT creation rights for the second type of MCT are conditioned upon possession of some physical media, then such a licensing model would simulate different rights for the original, the first generation copies, and the second generation copies. It would also allow for some limited preview of the content by people who hold neither the original nor first or second generation virtual copies.

The following licenses demonstrate an application of the MCT idea to a piece of content (703) identified by 12.345 that is available for use in repositories (601) only during the month of December, 2005. The content is available for use from physical media (700) during that time (see FIG. 7 element 702 and license #1 below). It is also available during that time for use in the presence of MCT with identifier MCTIssuer:123CABEE (see FIG. 7 element 702 and license #2 below). MCT with identifier MCTIssuer:123CABEE can be created by a MCT repository (602) upon communication with publisher.com to satisfy any fees and count restrictions put in place at publisher.com's website (see FIG. 7 element 701 and license #3 below). MCT with identifier MCTlsuser:123CABEE can be freely copied to any MCT repository (602) with security level 7 or higher (see FIG. 7, element 701 and license #4 below).

License #1:

```
<?xml version=“1.0” encoding=“UTF-8”?>
<r:license ...>
  <r:grant>
    <physical:disk>
      <physical:volumeId>XYZDWYZDXYZDXYZDXYZDXQ
      ==<physical:volumeId>
    </physical:disk>
    <mx:play>
    <e:book>
      <e:identifier>12.345</e:identifier>
    </e:book>
    <r:validityInterval>
      <r:notBefore>2005-12-01T00:00:00</r:notBefore>
      <r:notAfter>2006-01-01T00:00:00</r:notAfter>
    </r:validityInterval>
  </r:grant>
  <r:issuer>
    <dsig:Signature
      ...
      <dsig:KeyInfo>
        <dsig:KeyValue>
          <dsig:RSAKeyValue>
            <dsig:Modulus>PublishersKeyQ==</dsig:Modulus>
            <dsig:Exponent>AQABAA==</dsig:Exponent>
          </dsig:RSAKeyValue>
        </dsig:KeyValue>
      </dsig:KeyInfo>
    </dsig:Signature>
  </r:issuer>
</r:license>
```

License #2:

```
<?xml version=“1.0” encoding= “UTF-8”?>
<r:license ...>
  <r:grant>
    <met:managedCopyToken>
      <r:keyHolder>
        <r:info>
          <dsig:KeyValue>
            <dsig:RSAKeyValue>
              <dsig:Modulus>MCTIssuersKeyQ==
              </dsig:Modulus>
              <dsig:Exponent>AQABAA==
              </dsig:Exponent>
            </dsig:RSAKeyValue>
          </dsig:KeyValue>
        </r:info>
      </r:keyHolder>
      <met:distinguisher>123CABEE</met:distinguisher>
    </met:managedCopyToken>
    <mx:play/>
    <e:tbsri>
      <e:identifier>12.345</e:identifier>
    </e:tbsri>
    <r:validityInterval>
      <r:notBefore>2005-12-01T00:00:00</r:notBefore>
      <r:notAfter>2006-01-01T00:00:00</r:notAfter>
    </r:validityInterval>
  </r:grant>
  <r:issuer>
    <dsig:Signature>
      ...
      <dsig:KeyInfo>
        <dsig:KeyValue>
          <dsig:RSAKeyValue>
            <dsig:Modulus>PublishersKeyQ==
            </dsig:Modulus>
            <dsig:Exponent>AQABAA==
            </dsig:Exponent>
          </dsig:RSAKeyValue>
        </dsig:KeyValue>
      </dsig:KeyInfo>
    </dsig:Signature>
  </r:issuer>
</r:license>
```

License #3:

```
<?xml version=“1.0” encoding=“UTF-8”?>
<r:license ...>
  <r:grant>
    <physical:disk>
      <physical:volumeId>XYZDWYZDXYZDXYZDXYZDXQ
      ==<physical:volumeId>
    </physical:disk>
    <met:creatMet/>
    <met:managedCopyToken>
      <r:keyHolder>
        <r:info>
          <dsig:KeyValue>
            <dsig:RSAKeyValue>
              <dsig:Modulus>MCTIssuersKeyQ==
              </dsig:Modulus>
              <dsig:Exponent>AQABAA==
              </dsig:Exponent>
            </dsig:RSAKeyValue>
          </dsig:KeyValue>
        </r:info>
      </r:keyHolder>
      <met:distinguisher>123CABEE</met:distinguisher>
    </met:managedCopyToken>
    <r:exerciseMechansim>
      <r:exerciseService>
        <r:serviceReference>
          <met:service protocol=“4” address=
          “http://publisher.com/”/>
        </r:serviceReference>
      </r:exerciseService>
    </r:exerciseMechansim>
  </r:grant>
  <r:issuer>
    <dsig:Signature
      ...
      <dsig:KeyInfo>
        <dsig:KeyValue>
          <dsig:RSAKeyValue>
            <dsig:Modulus>MCTIssuersKeyQ==
            </dsig:Modulus>
            <dsig:Exponent>AQABAA==
            </dsig:Exponent>
          </dsig:RSAKeyValue>
        </dsig:KeyValue>
      </dsig:KeyInfo>
    </dsig:Signature>
  </r:issuer>
</r:license>
```

License #4:

```
<?xml version=“1.0” encoding=“UTF-8”?>
<r:license ...>
  <r:grant>
    <r:forAll varName=“p”/>
    <r:keyHolder varRef=“p”/>
    <met:requestMetTransfer/>
    <met:managedCopyToken>
      <r:keyHolder>
        <r:info>
          <dsig:KeyValue>
            <dsig:RSAKeyValue>
              <dsig:Modulus>MCTIssuersKeyQ==
              </dsig:Modulus>
              <dsig:Exponent>AQABAA==
              </dsig:Exponent>
            </dsig:RSAKeyValue>
          </dsig:KeyValue>
        </r:info>
      </r:keyHolder>
      <met:distinguisher>123CABEE</met:distinguisher>
    </met:managedCopyToken>
    <r:prerequisiteRight>
      <r:keyHolder varRef=“p”/>
      <r:possessProperty/>
      <sx:propertyUri definition=“http://www.security
      People.com/securityLevel/7”/>
      <r:trustedRootIssuers>
        <r:keyHolder>
          <r:info>
            <dsig:KeyValue>
              <dsig:RSAKeyValue>
                <dsig:Modulus>SecurityPeoplesKeyQ=
                </dsig:Modulus>
                <dsig:Exponent>AQABAA==
                </dsig:Exponent>
              </dsig:RSAKeyValue>
            </dsig:KeyValue>
          </r:info>
        </r:keyHolder>
      </r:trustedRootIssuers>
    </r:prerequisiteRight>
  </r:grant>
  <r:issuer>
    <dsig:Signature>
      ...
      <dsig:KeyInfo>
        <dsig:KeyValue>
          <dsig:RSAKeyValue>
            <dsig:Modulus>MCTIssuersKeyQ==
            </dsig:Modulus>
            <dsig:Exponent>AQABAA==
            </dsig:Exponent>
          </dsig:RSAKeyValue>
        </dsig:KeyValue>
      </dsig:KeyInfo>
    </dsig:Signature>
  </r:issuer>
</r:license>
```

The above description of MCTs relates to MCTs that are permanent after created. It is also possible to have MCTs that are created with a specified lifetime (1004). After their lifetime since creation lapses, MCTs are destroyed. Or, it is possible to have MCTs that carry an indication of their creation time (902, 1003), so that other licenses that require the presence of MCTs can require the presence of MCTs newer or older than a certain date, for example. Other variations are possible as might be obvious to one skilled in the art, such as territory-bound MCTs (1005) that cannot move out of the territory in which they were created. Such advanced classes of MCTs can be implemented in a number of ways. One example is to use a grammar for MCT identification that includes the class of MCT including creation territory and creation time. Another way is to store this information in a database.

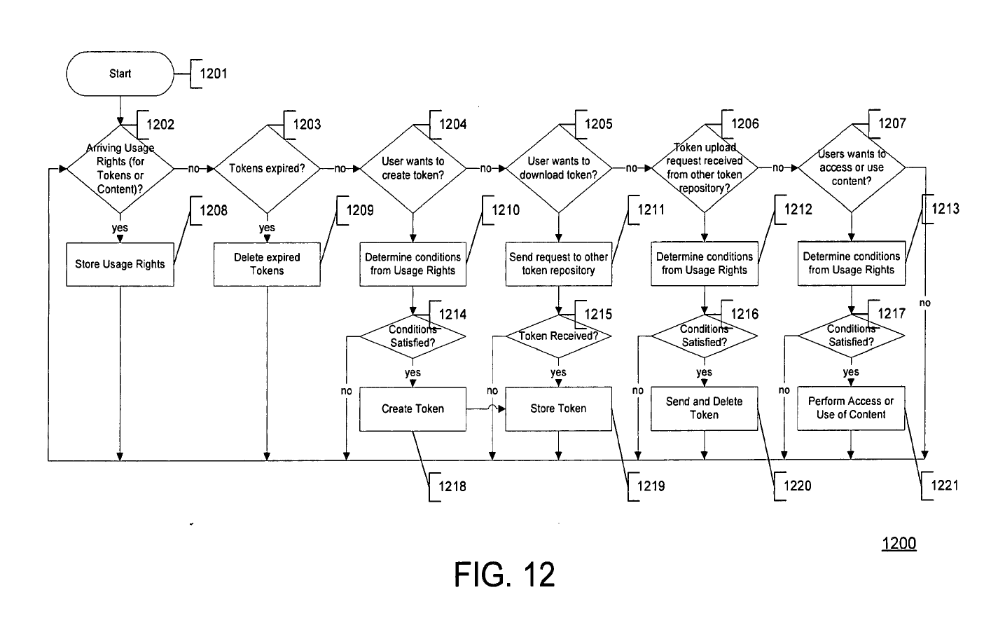

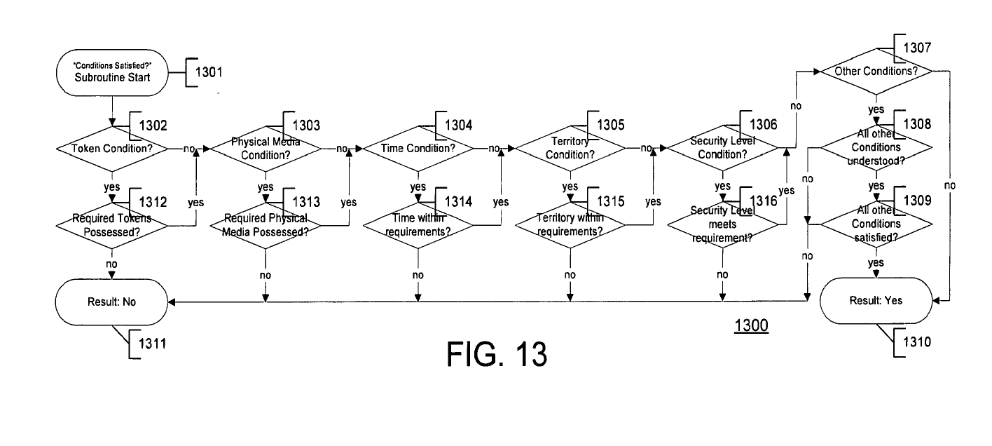

FIG. 12 shows a flow utilizing MCTs. The flow starts at step 1201. At step 1202, the system checks whether any usage rights for tokens or content have arrived. If so, they are stored in step 1208. If no more usage rights are arriving, the system checks in step 1203 if any tokens have expired. If so, the expired tokens are deleted at step 1209. If no tokens are expiring, the system checks at step 1204 if the user wants to create a token. If so, the conditions for creating that token are determined in step 1210 from the usage rights. In step 1214, the system determines if the conditions are satisfied. If not, the token is not created and the process starts over. On the other hand, if the conditions are satisfied, the token is created in step 1218 and stored in step 1219. If the user does not want to create any token in step 1204, the system checks in step 1205 if the user wants to download a token. If so, the system sends in step 1211 a request for the token to the token repository including the token and then waits for a reply. If the requested token is received at step 1215, it is stored at step 1219. If the user does not want to download any token in step 1205, the system checks in step 1206 whether any other token repository is requesting to obtain a token from the local token repository. If so, the system determines in step 1212 the usage rights associated with the transferring of the requested token and the conditions on those usage rights. Then, in step 1216, the system checks if those conditions are satisfied (more detail in FIG. 13). If so, the token is sent in step 1220 to the requesting token repository and deleted from the local token repository. If no other system wants to obtain a token from the local token repository in step 1206, the system checks in step 1207 if the user wants to access or use any content. If so, the system determines in step 1213 the usage rights associated with the access or use of the content and the conditions on those usage rights. Then, in step 1217, the system checks if those conditions are satisfied (more detail in FIG. 13). If so, the system performs the requested access or use of the content in step 1221.

FIG. 13 provides more detail on how the system determines if conditions are satisfied. The subroutine starts in step 1301. In steps 1302, 1303, 1304, 1305, and 1306, the system checks if any of some predefined conditions are present in the list of conditions. If not, the system moves on to check the next type of condition. If so, the system evaluates the particular condition. If the particular condition is found to be satisfied, the system goes on to the next type of condition. If the particular condition is not found to be satisfied, the subroutine terminates with the result of “No” at step 1311. In step 1312, the system would check if the required tokens are present in the token repository. For example, if playing were permitted with a token condition of ABC, then token ABC would need to exist in the token repository for playing to occur. In step 1313, the system would check if the required physical media was possessed. To do this, it could communicate with a disk drive to verify the media's presence in the drive. In step 1314, the system would check if the time requirements were satisfied. It could keep a secure clock to have a reasonably accurate indication of the current time. Then it would check if this indication indicates that the time is before, after, or in another relation with the particular time condition. In step 1315, the system would check if the territory condition is satisfied. It might do this using a global positioning system, a local network, or by other means such as by having a maximum of one territory associated with each device. If the determined territory of the device was within the territories mentioned in the condition the condition would be satisfied. In step 1316, the system would check security level requirements. For example, a token might only be allowed to transfer to repositories with a certain security level, so the system could find out the security level of the requesting repository using some certificates and then check if it met or exceeded the level required in the conditions. Once all pre-defined conditions are checked, flow proceeds to step 1307, where the system checks for other conditions. If no other conditions are found, the subroutine terminates with the result of “Yes” at step 1310. If other conditions are found, the system makes sure it understands all the other conditions at step 1308. If it doesn't understand some, the subroutine terminates with the result of “No” at step 1311. Otherwise (if the system understands all the other conditions), the system checks in step 1309 if all the other conditions are satisfied and terminates in “Yes” at step 1310 or “No” at step 1311 accordingly.

The above described exemplary embodiments, advantageously, provide virtual copies, first sale, and differential rights to different-class (generation, disk/nodisk, etc.) copies.

In another embodiment of the present invention, the allowed showing of content on a physical media is coordinated with the broadcast of that same content. In other words, copies of a digital content package, such as a movie, can be distributed in protected format so that they may not be viewed before such content debuts in broadcast format.

Further exemplary embodiments are related to the business model of USPS as a Cable Channel (e.g., HBO via USPS). This exemplary embodiment solves the problem for content aggregators like HBO, and other channel operators, to package content together to distribute to the consumer. Typically, HBO makes agreements with content distributors like DirecTV and Cable operators. The HBO channel is delivered to various content distributors and transmitted into the home.

However, HBO may like to be able to provide their aggregated content via other means than cable and satellite. Another avenue would be to deliver HBO content over IP delivery. There is, however, another opportunity to deliver HBO content over a new distribution means, such as optical disk, and the liked.

An exemplary embodiment includes the combination of two new technologies to provide a unique new distribution means for HBO or others, i.e., the combination of HD optical disk storage and DRM technology. For example, if HBO where to package their content on optical disk with a specific month of lifecycle, they would mail the May discs to consumers via physical mail, in late April. The discs would arrive at the consumer's household as part of a subscription model. On the first day in May, the disks would be playable, but not before or after the month of May '05, as an example.

In addition, HBO could restrict the specific days that the content is playable to coincide with they days the HBO channel provides the same content. At a finer level of granularity, it could further be restricted to the specific times that the broadcast is made (e.g., May 16, 2005 GMT 8:00 am, 12:00 pm, and 3:00 pm, etc.). The consumer would read the content of the disc in a coincident manner to the time of broadcast.

If this last case where implemented, it literally could be a “Broadcast” from the disk. The consumer would insert the disc and content would come off the disk coincident with the Broadcast by HBO.

Advantageously, a consumer that elects to receive content via broadcast (e.g., Terrestrial Digital HD) could still have HBO as a channel choice via this alternative mechanism.

Accordingly, in this exemplary embodiment, the combination of HD optical disk storage and DRM technology can provide a unique new distribution means for HBO or others. For example, if HBO where to package their content on optical disk with a specific event in mind that would trigger the ability to use the disk, they would mail the discs to consumers via physical mail, in late April. The discs would arrive at the consumer's household as part of a subscription model. As soon as the event happened the disks would be playable but not before the event. As an example, the event could be that HBO decides to broadcast the content on the disk on a certain date. The making available of the content on that date could be accomplished by providing on the disk an HBO URL that can be contacted to supply code to unlock the disk once the event is known.

In addition, HBO could restrict the specific days that the content is playable to coincide with the days the HBO channel provides the same content and of course those days might not be known when the disk is distributed so the relevant event would be determination of the dates. At a finer level of granularity, it could further be restricted to the specific times that the broadcast is made (e.g., May 16, 2005 GMT 8:00 am, 12:00 pm, and 3:00 pm, etc.) The consumer would read the content of the disc in a coincident manner to the time of broadcast.

If this last case where implemented, it literally could be a “Broadcast” from the disk. The consumer would insert the disc and content would come off the disk coincident with the Broadcast by HBO and that broadcast time need not be known when the disks are distributed via USPS.

Advantageously, a consumer that elects to receive content via broadcast (e.g., Terrestrial Digital HD) could still have HBO as a channel choice via this alternative mechanism.

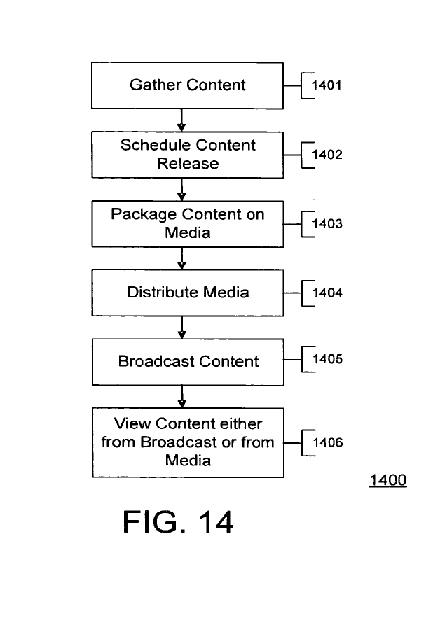

FIG. 14 shows the steps involved in content distribution. At step 1401 content is gathered while at step 1402 a release date for the content is scheduled. The content is packaged at 1403 onto physical media and then it is distributed at 1404. Finally the content is broadcast at 1405 and the content can then be viewed either from the broadcast or the physical media.

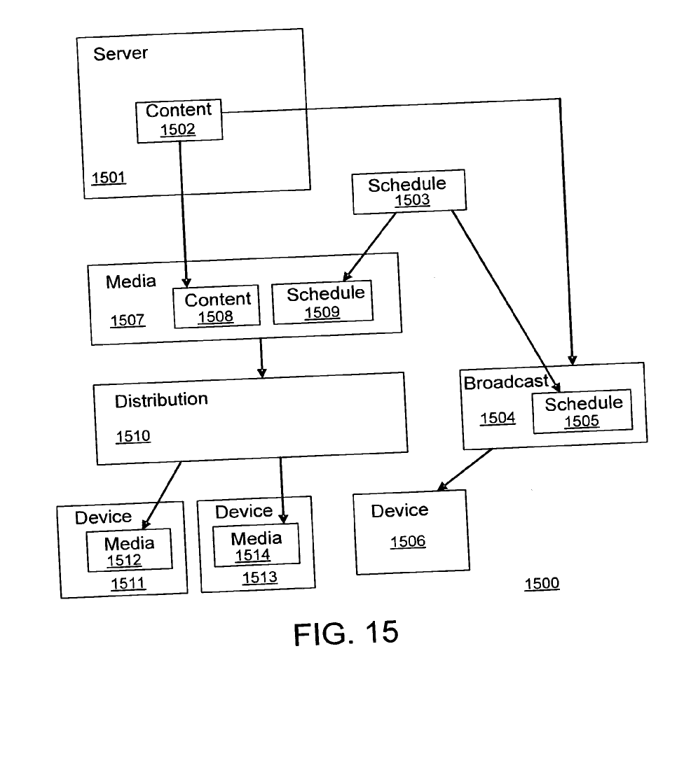

FIG. 15 shows an embodiment of a system for implementing this aspect of the invention. The system has a server 1501 which gathers content 1502. A scheduler 1503 sets a schedule for the opening of viewing for the content 1502 and that schedule 1509 is packaged with the content 1508 on media 1507. The broadcast schedule 1505 is sent to the broadcast server 1504 which then controls the broadcast to device 1506 according to schedule 1505.

The physical media is then distributed via distribution system 1510 and copies such as 1512 and 1514 of the content on physical media can then be played on devices 1511 and 1513 respectively subject to the schedule 1509.

It should be readily apparent that schedules 1505 and 1509 need not be identical or even of the same form. For example schedule 1505 may include a date and time of broadcast or of multiple dates and times. It might also include information regarding the distribution such as network (e.g., HBO, ESPN), channel number and distribution system (e.g., cable, satellite, over the air, etc.). Schedule 1509, in contrast may not have set viewing times but rather windows. Such windows could be open ended such as allowing the content to be viewed at any time after a certain date and time. Alternatively, such windows could be closed thereby only allowing viewing during a set period of time. Multiple windows and other structures are also possible. In addition, windows can be combined with other usage rights such as, for example, limits on the number of times content can be viewed. Alternatively, there might be separate windows for viewing and copying which could be either distinct or overlapping to some degree or another. Other arrangements will be readily apparent to those skilled in the art. Nevertheless, it should be understood that one embodiment of this invention is to have a schedule 1509 for the physical media that allows the physical media to be distributed to end-users so that end-users of physical devices such as 1511 and 1512 get access to the content at the same time as end-users of devices such as 1506 which receive content broadcast according to schedule 1505.

In a further embodiment of the present invention, usage rights that are associated with a first DRM environment are sent both translated and untranslated when content is transferred from the first DRM environment to a second DRM environment. In doing so, the original usage rights are preserved to be used if the content returns to the first DRM environment or if the usage rights need to be translated for a third DRM environment.

Further exemplary embodiments include transporting rich REL with DRM specific REL. This exemplary embodiment solves the problem that when a fixed MPEG REL license is used by several different DRM systems, each DRM system has its own rights expression support capabilities. For example, a DRM system may have its own rights expression, or only have the ability to support some subset of rights in MPEG REL.

In a traditional model, the REL would be delivered from A to B to C with the content. Transformations of the REL would occur at each step. Because each of the transformations is Lossy, A-C would give different rights to C than A-B-C, because of the path and transformations that occur. This exemplary embodiment resolves this problem by permitting transformations of the REL to the specific DRM systems, but preserving the original source REL. In this mode, A would create a transform of REL A(REL), but maintain REL. When the content is delivered to B, the rights REL and A(REL) are transmitted. B could either then operate on REL or A(REL), if B was capable. In addition, B could perform its own transform. B would then be able to use REL, A(REL) or B(REL).

If the content where then delivered to C, the rights REL, A(REL) and B(REL) would also be delivered. To be clear, A(REL) is REL cast in a way that A can understand REL. It is not rights assigned to A. C could then operate against any of the rights described, REL, A(REL) or B(REL). In addition, if none of those where operable by C, it could create C(REL), and the like.

The transmission of A(REL) to B can be optional. For example, if requested, A could transmit the content and REL instead of content with REL and A(REL). Advantageously, each subsequent system has the ability to see the original REL and operate against it or against a transformation that has occurred previously.

It is assumed that each of these transforms is Lossy, but compliant. For example, if A performs a transform, then A(REL) describes a subset of usage permitted by REL. If A(REL) describes usages beyond REL, then that can only occur under the guidance or approval of some compliance body that specifically permits the extension of rights.

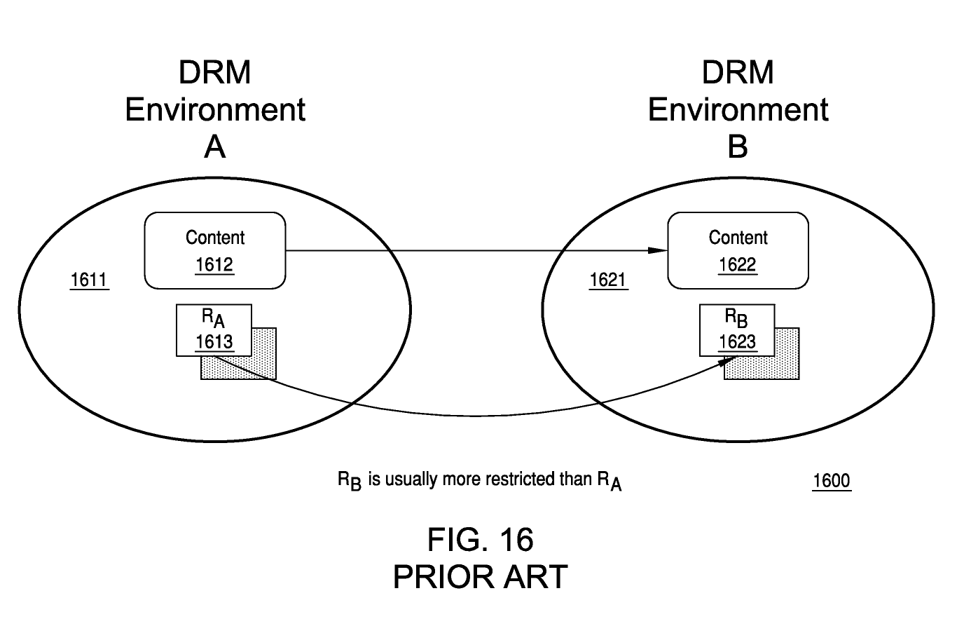

FIG. 16 depicts prior art usage rights processing. A DRM Environment A, shown 1611, has content 1612 and usage rights R_{A} shown as 1613. When the content is transferred to DRM Environment B, shown as 1621, the usage rights R_{A} get translated into usage rights R_{B} shown as 1623. Typically, when usage rights get translated they get more restrictive.

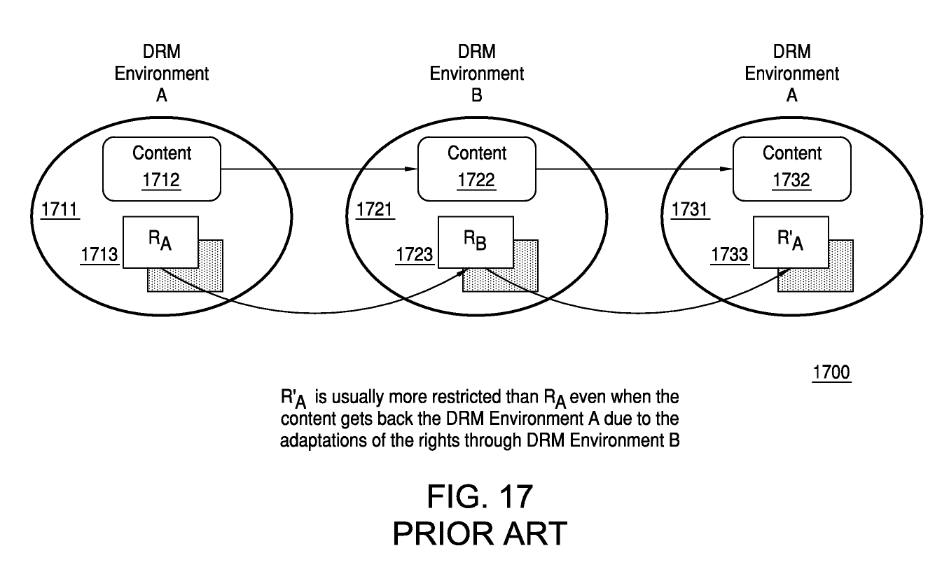

In FIG. 17, which also depicts a prior art scenario, the content and usage rights are sent back DRM Environment A shown as 1731. Thus the usage rights must be translated from R_{B} back to R_{A}. Due to the fact that R_{B} is likely to be more restrictive than R_{A}, and given that translations will likely result in more restrictive usage rights, this translation results in usage rights R′_{A}, shown as 1733, which are more restrictive than R_{A}. Thus after this second transfer from DRM Environment B 1721 back to DRM Environment A, the resulting usage rights R′_{A} are more restrictive than they need to be.

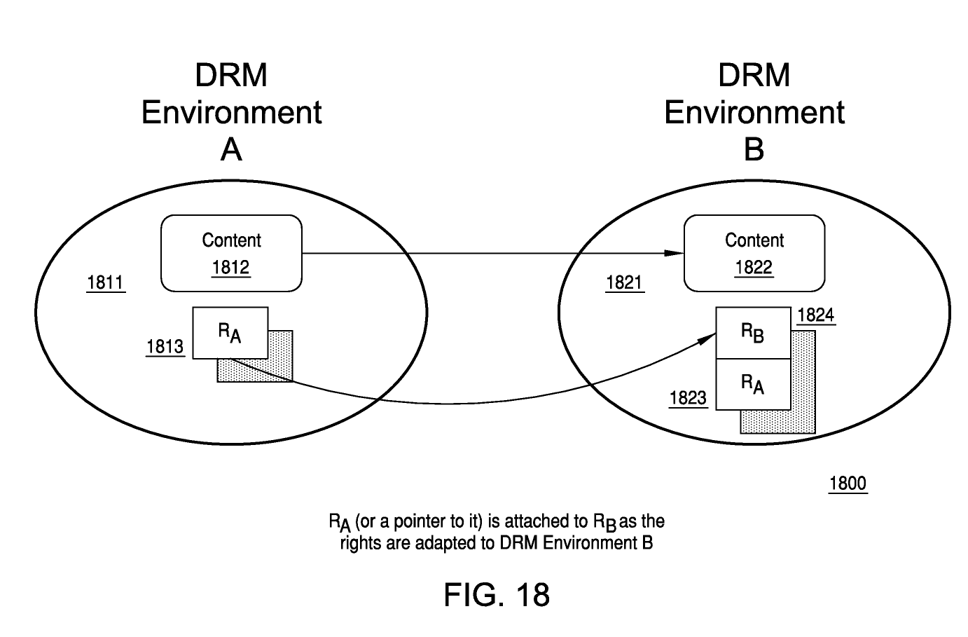

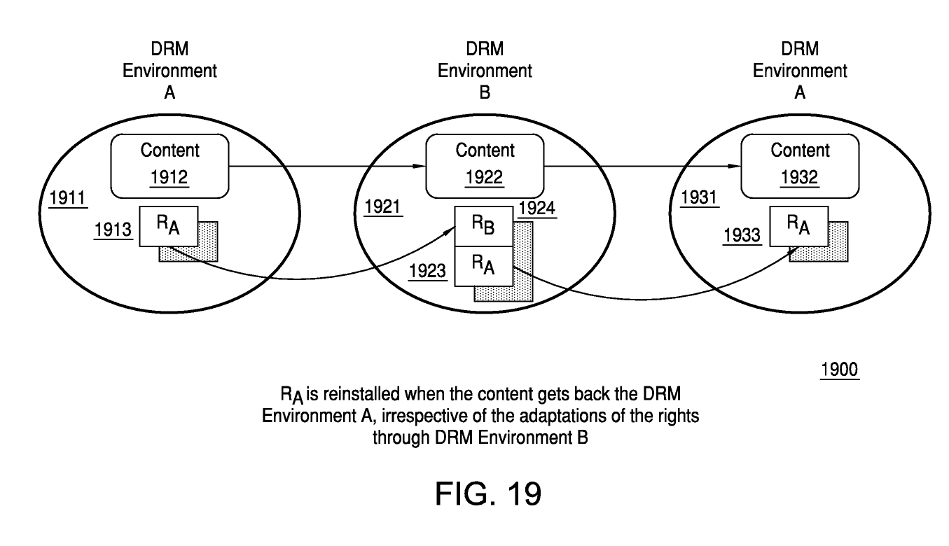

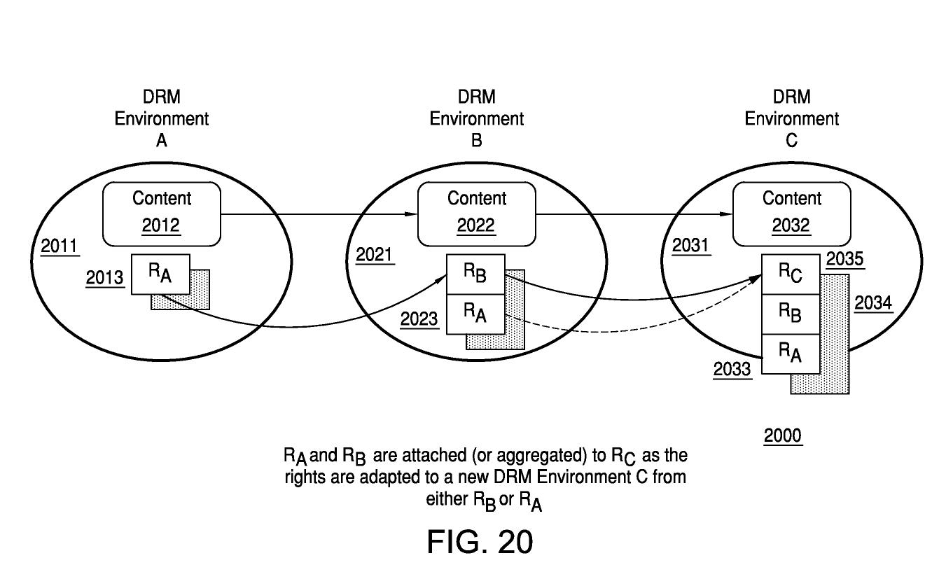

One embodiment of the present invention which addresses the problems with the prior art discussed in connection with FIGS. 16 and 17 is shown in its simplest form in FIG. 18. In FIG. 18, content 1812 and usage rights 1813 from DRM Environment A 1811 are sent to DRM Environment B 1821. In this embodiment of the invention two sets of usage rights are associated with the content 1822 in DRM Environment B 1821. One set is the original usage rights R_{A} shown here as 1823. The other set is the translated usage rights R_{B} shown as 1824 which can be enforced in DRM Environment B 1821. This provides two advantages. First, if the content is sent back to DRM Environment A, then the necessary rights R_{A} are already associated with the content and no translation is necessary as shown in FIG. 19. Further, if the content is sent to third DRM Environment, then the usage rights for that third DRM Environment can be translated from the original R_{A} instead of from R_{B} as is shown in FIG. 20. This prevents potentially unnecessary restrictions in usage rights occasioned by successive translations which each result in narrower usage rights.

In FIG. 19, the content 1922 in DRM Environment B 1921 is associated with two sets of usage rights, namely R_{A} 1923 and R_{B} 1924. R_{B} 1924 is a set of usage rights derived by translating R_{A} 1913 for DRM Environment B 1921. While R_{A} 1923 is the same set of rights used in DRM Environment A 1911. Thus when the content is transferred from DRM Environment B 1921 to DRM Environment A 1931 there is no need to translate usage rights R_{B} into R′_{A} as shown in prior art FIG. 17. Instead, the present invention, as illustrated in FIG. 19 shows that usage rights R_{A} 1923 which remain associated with content 1922 in DRM Environment B 1921 are merely passed with the content to DRM Environment A 1931. Thus by both associating both a copy of the original usage rights R_{A} and the translated usage rights R_{B} with the content in DRM Environment B 1921, there is no need to translate the rights back into usage rights for DRM Environment A when content and rights move back to DRM Environment A. Instead, the original, untranslated rights are used.

In FIG. 20, content 2012 and usage rights 2013 from DRM Environment A 2011 are sent to DRM Environment B 2021. In accordance with one aspect of the present invention, the content in DRM Environment B 2021 is associated with both a set of usage rights that has been translated for Environment B, namely usage rights R_{B} 2024, as well with a copy of the original usage rights R_{A} shown as 2023. When the content gets transferred to a third DRM Environment C 2031, the translated usage rights R_{c} 2035 can be translated from the original usage rights R_{A}, which are associated with the content 2022 in DRM Environment B 2021. In this way, the usage rights R_{A} need to be translated only a single time to derive usage rights R_{C}. In this way, the usage rights are not unnecessarily narrowed through multiple translation processes.

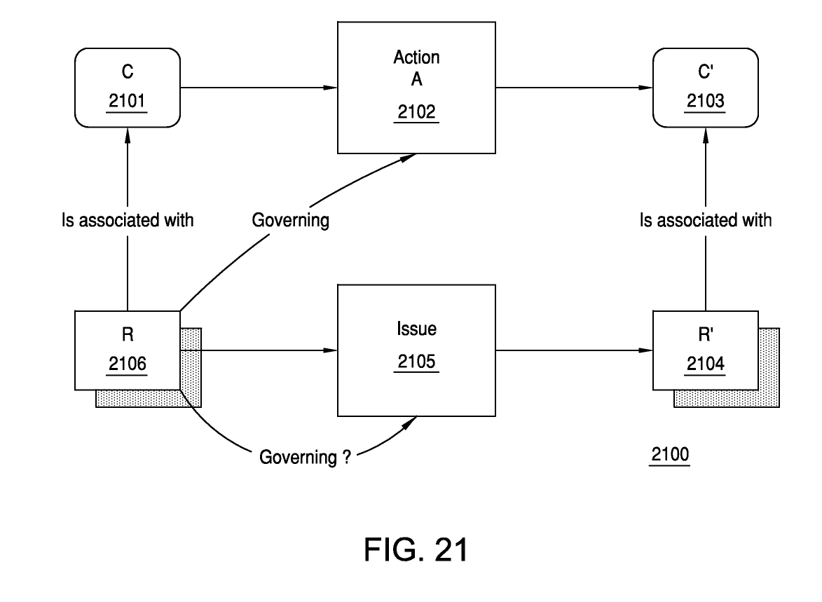

Another aspect of the present invention is shown in FIG. 21 which shows how usage rights can be associated with modified content. Usage rights R 2106 are associated with content 2101. Usage rights R 2106 include meta-rights set forth what kind of rights can be issued to modified versions of content c 2101 shown here as C′ 2103. In accordance with this aspect of the invention, when a permitted action A 2102 is taken to modify content C 2101 into modified content C′ 2103, a set of usage rights R′ 2104 is issued and associated with content C′ pursuant to the right and meta-rights of usage rights 2106.

Further exemplary embodiments provide methods and systems for specifying rights for resources resulting from exercising of other rights. In an exemplary embodiment, exercising a right on a resource in many cases results in generating new or derived resources. For example, editing a document often creates a new document, extracting a portion out of a document and then inserting it into another document also end up with a new document, and adapting a video to a different bit rate yields a derived version of the video content. When granting rights of this type, one may also be interested in specifying rights for the resources to be generated as the result of exercising the granted rights. For example, one may want to specify that a distributor has the right to sell the play right for a video, and also has the right adapt it to some lower bit rates to sell the same play right but for less money.

Considering exercising a right as a process that can take some (zero or more) resources as input and produce some (zero or more) other resources as output, the idea of this exemplary embodiment is to devise methods and systems for:
1. identifying those resources to be generated and quantifying any constraints on those resources and their metadata,
2. specifying rights for those resources at the time the right to be exercised is specified, and
3. issuing rights for those resources after they are generated.

Specifically, this exemplary embodiment includes:
1. using variables and their quantification to identify resources to be generated,
2. treating the right to exercise and the right to issue rights for resource generated by the exercise as two different but related rights, and defining the scope of the variables defined above to cover the both exercise and issue rights,
3. sharing the dynamic information carried by the variables between the two rights (especially from the exercise right to the issue right), and the information sharing can be:
   a. transient—for the cases where issuing new rights is together with generating new resources or
   b. persistent—for the cases where they are not together.

Advantageously, the exemplary embodiment solves the problem of specifying rights for resources to be generated as the result of exercising other rights. It is currently cumbersome to deal with this problem. For example, DPRL uses the mechanism of “nextRight” to allow inheriting the existing rights from the input resource, and adding rights to or subtracting rights from the existing rights. This mechanism is not flexible, however, in that (a) it is hard to apply it to the cases where two or more resources are generated and they have different sets of rights, (b) it does not support specifying a different set of rights as the combination of adding and subtracting rights, and (c) it does not support indication of who has the right to issue those rights.

Issuing rights for newly generated resources can be dependent upon exercising the right for generating the resources. The dynamic (and hence variable) information, such as identification and other metadata that is not known in advance and only becomes available during the exercise of the right has to be captured and used in the right to issue rights. Currently in REL, variables are only specified for and used within exercising a right (e.g., inside a grant). A novel aspect of this exemplary embodiment is to allow capture and usage of the dynamic information across different but related rights (such as adapt and issue).

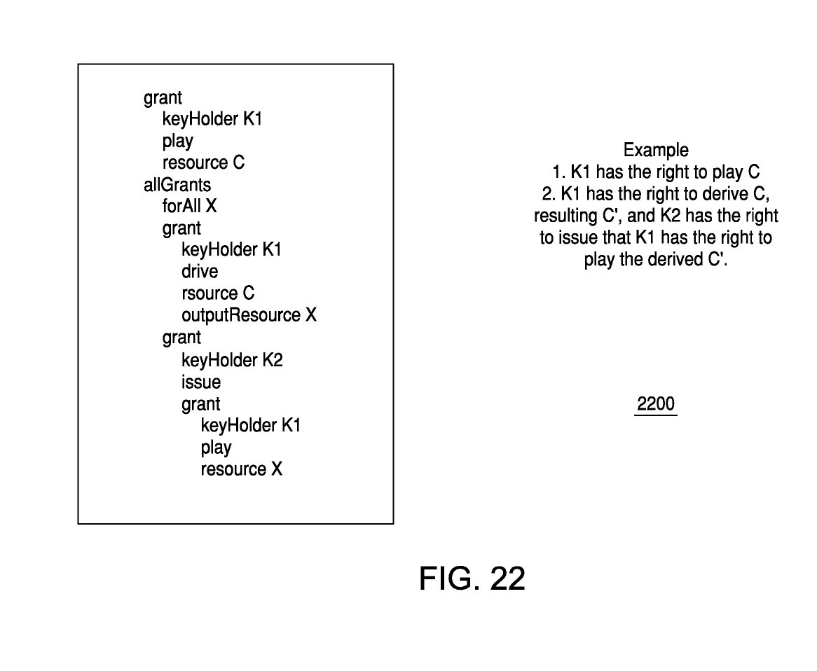

Accordingly, FIG. 22 shows an exemplary license 2200, wherein keyholder 1 (K1) has the right to play resource C, and derive the resource C resulting in derived resource C′, and keyholder 2 (K2) has the right to issue a license granting K1 the right to play the derived resource C′.

Advantageously, the exemplary embodiments can be used to augment, for example, the Advanced Access Content System (AACS), by providing capabilities that enhance those offered by AACS. The exemplary embodiments achieve this by offering sophisticated usage rules that are specified as rights expressions using an international standard rights expression language, for example, the MPEG REL. The exemplary usage rules can include many parameters, such as fees, geographical restrictions, target DRM systems, dates, resolutions, tracking, and the like. The exemplary embodiments also offer an Advanced Copy right that allows users to create and use a copy governed by usage rules that are flexible and can vary on a title-by-title basis.

The exemplary usage rules can be optional AACS usage rules. AACS players not interpreting the exemplary usage rules function like ordinary AACS players. On the other hand, if AACS players interpret and enforce the exemplary usage rules, new uses of the content can be offered to consumers. In this way, the exemplary embodiments provide an extensible, flexible platform to facilitate a wide variety of business models for AACS protected content.

The exemplary embodiments need not support recordable media. In addition, the exemplary embodiments need not support acquisition of usage rules via mechanisms other than those supported by AACS. While support for these features is a natural use of the MPEG REL and expands the options available to the AACS systems, support for these features requires additional architectural consideration.

The exemplary embodiments can include:

An Interface Book, which specifies an extension and profile for AACS HD DVD specific rights expressions and the mechanisms for integrating the expressions with the AACS HD DVD pre-recorded media and players.

A Rights Expression Book, which specifies the common MPEG REL extensions and profiles for AACS as well as for other DRM systems in the media and entertainment market.

A Protocol Book, which specifies the common rights protocols such as rights authorization and rights issuance protocols for AACS as well as for other DRM systems in the media and entertainment market.

Technical Compliance Rules, which specify the technical compliance and robustness rules required for compliant implementations.

Exemplary Business Models, which capture the target business models that are currently supported by the exemplary embodiments.

Architecture Scope and Assumptions, which capture the architecture scope intended to be supported for the exemplary embodiments and some assumptions and issues upon which the scope relies.

The following section covers general information including scope; normative references; terms, definitions, symbols, and abbreviated terms; and namespaces and conventions.

The normative references can include:

ISO/IEC 21000-5:2004, Information technology—Multimedia framework (MPEG-21)—Rights Expression Language

XMLSCHEMA, XML Schema Part 1: Structures and Part 2: Datatypes, W3C Recommendation, 2 May 2001, available at <http://www.w3.org/TR/2001/REC-xmlschema-1-20010502> and <http://www.w3.org/TR/2001/REC-xmlschema-2-20010502>

AACS HD DVD and DVD Pre-recorded Book, AACS LA, Version 0.9, Release Candidate 3, 11 Aug. 2005.

The terms, definitions, symbols, and abbreviated terms can be given in Clause 3 of ISO/IEC 21000-5:2004.

The namespaces and conventions can be given in Clause 4 of ISO/IEC 21000-5:2004, except for the namespace prefixes given in Table 1 below.

TABLE 1
Namespace prefixes

| Namespace prefix | Namespace |
|---|---|
| r | urn:mpeg:mpeg21:2003:01-REL-R-NS |
| sx | urn:mpeg:mpeg21:2003:01-REL-SX-NS |
| mx | urn:mpeg:mpeg21:2003:01-REL-MX-NS |
| bpx | urn:mpeg:mpeg21:2005:01-REL-BPX-NS |
| aacs | http://www.tbd.org/2005/REL/AACS/HDDVD |
| xsd | http://www.w3.org/2001/XMLSchema |
| xsi | http://www.w3.org/2001/XMLSchema-instance |

The following section specifies the interface-specific extensions to the MPEG REL. The goal of the interface-specific extensions is to provide a way to express rights and conditions relying on functionality that is only provided by AACS. These rights and conditions can be used to provide additional offerings to the consumer beyond the offerings enabled by the common Rights Expression Book. These additional offerings are not expected to be common with future exemplary interfaces. The potential for cross-interface adoption of the features in this interface book (for example, managed copy) will be evaluated in the coming months, and future versions of the exemplary embodiments might elevate the support for such features to the common exemplary books.

The following section specifies the syntax and semantics of the AACS HD DVD Pre-recorded Extension to the REL. Subsequent sections present a brief informative description of the features offered by this extension, followed by the full normative description.

The AACS HD DVD Pre-recorded Extension defines the following new conditions:

DiskInDrive: requires the presence of an HD DVD to exercise a right

UrPtr: limits the exercise of a right to particular group of enhanced video object sets (EVOBs) within a play list

The extension also defines authorization context properties that support the new conditions:

evobsUrPtr( ): a usage rule pointer shared by all EVOBs

pmsn(a): an HD DVD's pre-recorded media serial number

volumeId(a): an HD DVD's volume ID

The extension also defines:

a QName for expressing the right to make a managed copy (for more information on managed copies, please see the AACS documentation)

a URI for indicating the AACS content provider identification system

a URI for indicating the AACS device identification system

a URI template for identifying a play list on an AACS disk using a URI

Further sections describe the two new conditions and provide examples of their use. For brevity, the details of the r:issuer element have been omitted from the examples.

The aacs:diskInDrive condition requires the presence of an HD DVD to exercise the granted right. The required HD DVD is identified by its volume ID, its serial number, or both.

The volume ID is the same for all HD DVDs that include the same content, whereas the serial number is unique to each HD DVD. If this condition includes the volume ID, any disk of a particular title satisfies the condition. If this condition includes the serial number, only one disk satisfies the condition. If this condition includes both the volume ID and the serial number, satisfying the condition requires that both pieces of information from the disk match those specified in the condition.

Using this condition ties the licensed digital content to a particular physical medium. For example, suppose the Big Movie Studio (Provider ID B188) is distributing an HD DVD (Content ID 12345678) including its award-nominated movie (video play list 001) to individuals who will choose the award winner. The Big Movie Studio wants to ensure that copies of its movie do not appear on the internet. The license for the award-nominated movie could use the diskInDrive condition to require the presence of the original HD DVD in order to play the movie, as in the example below:

### Example

```
<r:license>
  <r:grant>
  <mx:play/>
    <r:digitalResource licensePartId=“AwardNominatedMovie”>
      <r:nonSecureIndirect URI=“http://www.tbd.org/2005/
      VPLST/AACS/HDDVD/B18812345678/001”/>
    </r:digitalResource>
    <aacs:diskInDrive>
    <aacs:volumeId>HLmR1ad8UJQ7jldhbK0pXQ==</aacs:volumeId>
    <aacs:pmsn>al0pXdhbKd87jHLUJmR1QQ==</aacs:pmsn>
  </aacs:diskInDrive>
  </r:grant>
  <r:issuer>...</r:issuer>
</r:license>
```

The aacs:urPtr condition limits the exercise of the granted right to those enhanced video object sets (EVOBs) on the disk that have a particular usage rule pointer.

An enhanced video object set (EVOB) is simply a program stream of audiovisual or audio data. An EVOB can be associated with a usage rule pointer, which points to a usage rule set stored in the title usage file. Several EVOBs can have the same usage rule pointer, so that a single usage rule set applies to several EVOBs.

Using this condition effectively creates a subset of a play list on an HD DVD by selecting the EVOBs to which a particular usage rule set is applied. For example, suppose the Big Movie Studio wants to license two versions of a movie, a G-rated version and a PG-rated version, but manufacture a single HD DVD. They could apply usage rule set 1 to the EVOBs that comprise the G-rated version of the movie and usage rule set 2 to all the other EVOBs. Each usage rule set could point to the same license with two grants, one which includes the urPtr condition to allow playing only those EVOBs whose usage rule pointer is 1 and one which doesn't include the urPtr condition and allows playing all the EVOBs regardless of pointer value. The second grant could require online permission to check for parental approval, for example.

### Example

```
<r:license>
  <r:grant>
  <mx:play/>
    <r:digitalResource licensePartId=“Movie”>
      <r:nonSecureIndirect URI=“http://www.tbd.org/2005/
      VPLST/AACS/HDDVD/B18812345678/001”/>
    </r:digitalResource>
    <aacs:urPtr>
    <aacs:ptrValue>1</aacs:ptrValue>
    </aacs:urPtr>
  </r:grant>
  <r:grant>
  <mx:play/>
    <r:digitalResource licensePartId=“Movie”>
      <r:nonSecureIndirect URI=“http://www.tbd.org/2005/
      VPLST/AACS/HDDVD/B18812345678/001”/>
    </r:digitalResource>
    <bpx:seekPermission>
      <r:serviceReference>
        <bpx:serviceLocation>
          <bpx:url>http://www.parental-approval.com/</bpx:url>
        </bpx:serviceLocation>
      </r:serviceReference>
    </bpx:seekPermission>
  </r:grant>
  <r:issuer>...</r:issuer>
</r:license>
```

Table 2 specifies the authorization context properties previously described and the statements they represent. If a property has the name given in the first column of Table and the value given in the second column of Table 2, then the statement represented by that property is the statement given in the third column of Table 2.

TABLE 2
Interface-specific extension authorization context properties

| Property name | Property value | Statement represented |
|---|---|---|
| aacs:evobsUrPtr( ) | a | a is an xsd:integer, and all of the EVOBs to be played back |
| | | in the requested performance have a UR_PTR value of a. |
| aacs:pmsn(a) | true | a is an xsd:base64Binary, and the requested performance |
| | | occurs on a device with an AACS HD DVD Pre-recorded |
| | | disk drive including an AACS HD DVD Pre-recorded disk |
| | | having a 128-bit pre-recorded media serial number equal to |
| | | the base64-decoded value of a. |
| aacs:volumeId(a) | true | a is an xsd:base64Binary, and the requested performance |
| | | occurs on a device with an AACS HD DVD Pre-recorded |
| | | disk drive including an AACS HD DVD Pre-recorded disk |
| | | having a 128-bit volume id equal to the base64-decoded |
| | | value of a. |

The following sections specify the semantics of a Rights Expression extension including elements and types that are specific to AACS HD DVD Pre-recorded media.

Let c be an aacs:DiskInDrive. Let (p, r, t, v, Σ, L, R) be an authorization request. Let (g, h, e) be an authorization story. Then c is Satisfied with respect to (p, r, t, v, Σ, L, R) and (g, h, e) if and only if both of the following are true:

if c/aacs:volumeId is present, Σ.aacs:volumeId (the value of c/aacs:volumeId) is true, and

if c/aacs:pmsn is present, X.aacs:pmsn (the value of c/aacs:pmsn) is true.

### Example

```
<aacs:diskInDrive>
  <aacs:volumeId>HLmR1ad8UJQ7jldhbK0pXQ
  ==</aacs:volumeId>
  <aacs:pmsn>al0pXdhbKd87jHLUJmR1QQ
  ==</aacs:pmsn>
</aacs:diskInDrive>
```

Let c be an aacs:UrPtr. Let (p, r, t, v, Σ, L, R) be an authorization request. Let (g, h, e) be an authorization story. Then c is Satisfied with respect to (p, r, t, v, Σ, L, R) and (g, h, e) if and only if the value of c/aacs:ptrValue is Equal to Σ.aacs:evobsUrPtr( ).

### Example

<aacs:urPtr>
<aacs:ptrValue>1</aacs:ptrValue>
</aacs:urPtr>

The QName aacs:managedCopy is for use with the governanceRule attribute of bpx:governedCopy and indicates the governance rules for managed copy as defined in the AACS Compliance Rules.

### Example

<bpx:governedCopy governanceRule=“aacs:managedCopy”/>

The URI http://www.tbd.org/2005/Provider/AACS/HDDVD is for use with the idSystem attribute of bpx:identityHolder and bpx:identityHolderPattern and indicates the identification system for content providers consisting of a 16-bit ID assigned by the AACS LA as described in 2.4 of AACS Pre-recorded Video Book. The 16-bit ID shall be base16-encoded for carriage in XML.

### Example

```
<bpx:identityHolder
  idSystem=“http://www.tbd.org/2005/
  Provider/AACS/HDDVD”
>A35D</bpx:identityHolder>
```

The URI http://www.tbd.org/2005/Device/AACS/HDDVD is for use with the idSystem attribute of bpx:identityHolder and bpx:identityHolderPattern and indicates the identification system for devices consisting of a 128-bit device unique nonce (see 5.1.1 of AACS HD DVD and DVD Pre-recorded Book) generated and maintained in compliance with all AACS compliance and robustness rules related to device unique nonces. The 128-bit ID shall be base64-encoded for carriage in XML.

### Example

```
<bpx:identityHolder
  idSystem=“http://www.tbd.org/2005/
  Device/AACS/HDDVD”
>ad8UJQ7jHLmR110pXdhbKQ
==</bpx:identityHolder>
```

The URI templates:

http://www.tbd.org/2005/VPLST/AACS/HDDVD/$$$$$$$$$$$$/%%% and
http://www.tbd.org/2005/APLST/AACS/HDDVD/$$$$$$$$$$$$/%%%

are for use with the URI attribute of r:nonSecureIndirect and identify the video play list or audio play list, respectively, with number %%% (see HD DVD-Video Specification) and associated with 6-byte AACS content certificate id $$$$$$$$$$$$ (see 2.4 of AACS Pre-recorded Video Book). The play list number is decimal-encoded. The content certificate id is base-16 encoded.

### Example

```
<r:digitalResource>
  <r:nonSecureIndirect
    URI=“http://www.tbd.org/2005/VPLST/
    AACS/HDDVD/A35D00000001/999”
  />
</r:digitalResource>
```

The following sections include a listing of the schema (XMLSCHEMA) that defines the XML syntax of the defined types and elements.

Schema for the interface-specific extension:

```
<?xml version=“1.0” encoding=“UTF-8”?>
<xsd:schema targetNamespace=“http://www.tbd.org/2005/REL/AACS”
xmlns:aacs=“http://www.tbd.org/2005/REL/AACS” xmlns:
r=“urn:mpeg:mpeg21:2003:01-REL-R-NS”
xmlns:xsd=“http://www.w3.org/2001/XMLSchema”
elementFormDefault=“qualified”
attributeFormDefault=“unqualified”>
  <xsd:import namespace=“urn:mpeg:mpeg21:2005:01-REL-BPX-NS”/>
  <xsd:import namespace=“urn:mpeg:mpeg21:2003:01-REL-R-NS”/>
  <xsd:complexType name=“DiskInDrive”>
    <xsd:complexContent>
      <xsd:extension base=“r:Condition”>
        <xsd:sequence minOccurs=“0”>
          <xsd:element name=“volumeId” type=“xsd:base64Binary”/>
          <xsd:element name=“pmsn” type=“xsd:base64Binary”
          minOccurs=“0”/>
        </xsd:sequence>
      </xsd:extension>
    </xsd:complexContent>
  </xsd:complexType>
  <xsd:element name=“diskInDrive” type=“aacs:DiskInDrive”
  substitutionGroup=“r:condition”/>
  <xsd:complexType name=“UrPtr”>
    <xsd:complexContent>
      <xsd:extension base=“r:Condition”>
        <xsd:sequence minOccurs=“0”>
          <xsd:element name=“ptrValue” type=“xsd:integer”/>
        </xsd:sequence>
      </xsd:extension>
    </xsd:complexContent>
  </xsd:complexType>
  <xsd:element name=“urPtr” type=“aacs:UrPtr” substitutionGroup=
  “r:condition”/>
</xsd:schema>
```

The following section specifies the interface-specific profiles. The goal of the interface-specific profiles is to drive convergence among implementations on common levels (basic and enhanced) of support, so that rights expression authors can write licenses that can be processed by the widest possible set of AACS HD DVD Pre-recorded disk players for the desired feature set.

This section specifies the Rights Expression profiles for AACS HD DVD Pre-recorded media. Two profiles are defined: basic and enhanced. The basic profile is intended to allow for expressing rights that are similar to the capability of a basic AACS player (modulo, perhaps, the ability to process usage rules). The enhanced profile is intended to allow for expressing rights that are similar in functionality to the functionality offered by an enhanced AACS player.

The Basic AACS HD DVD Pre-recorded Profile includes the AACS HD DVD Pre-recorded Extension previously described (except for managed copy) plus the following elements from the exemplary Rights Expression Profile defined in the exemplary Rights Expression Book: r:license, r:grant, r:digitalResource, r:nonSecureIndirect, r:issuer, r:allConditions, mx:play, and bpx:identityHolder.

The QName for indicating the Basic AACS HD DVD Pre-recorded Profile is aacs:basic.

All basic AACS players that process exemplary usage rules shall be able to process the Basic AACS HD DVD Pre-recorded Profile. Additionally, all such players shall be able to process Licenses including multiple r:grant elements by ignoring the r:grant elements that include any r:forAll, r:Principal, r:Right, or r:Condition the player does not recognize and by processing the remaining r:grant elements. Such players need not be able to process Licenses utilizing other extension points provided for in ISO/IEC 21000-5:2004.

The Enhanced AACS HD DVD Pre-recorded Profile includes the AACS HD DVD Pre-recorded Extension previously described plus the exemplary Rights Expression Profile defined in the exemplary Rights Expression Book. In addition to taking a value equal to one of the URIs previously described, the URI attribute of r:nonSecureIndirect may take a value equal to any of the URIs provided in the ID attributes of ResourceGroup elements in the “MNGCOPY_MANIFEST.XML” file in the “AACS” directory as specified in section 5.2 of AACS HD DVD and DVD Pre-recorded Book.

The QName for indicating the Enhanced AACS HD DVD Pre-recorded Profile is aacs:enhanced.

All enhanced AACS players that process exemplary usage rules shall be able to process the Enhanced AACS HD DVD Pre-recorded Profile. Additionally, all such players shall be able to process Licenses including multiple r:grant elements by ignoring the r:grant elements that include any r:Principal, r:Right, or r:Condition the player does not recognize and by processing the remaining r:grant elements. Such players need not be able to process Licenses utilizing other extension points provided for in ISO/IEC 21000-5:2004.

The following section specifies the carriage of the exemplary rights expressions on AACS HD DVD Pre-recorded disks.

Licenses are carried on HD DVD Pre-recorded media in one of two ways depending on the purpose of the licenses. Licenses for playing (including for issuing licenses for playing) and licenses for making copies are carried as further described.

Licenses for playing are carried using the REL Usage Rule defined in 3.4 of AACS HD DVD and DVD Pre-recorded Book. The REL Usage Rule shall carry or reference to an XML License that is well-formed, schema-valid, and in Schema Centric Canonical Form (see Schema Centric XML Canonicalization). If the REL Usage Rule carries or references to an XML License that is either not well-formed, not schema-valid, or not in Schema Centric Canonical Form, the behavior of the player cannot be guaranteed and is player-specific. If the player detects that the file is not well-formed, not schema-valid, or not in Schema Centric Canonical Form, the player shall report an error.

There may be a file, named “MNGCOPY_LICENSES.XML”, in the “AACS” directory. Licenses for making copies are carried in this file as children of its root element, which shall be r:licenseGroup. The r:licenseGroup shall be well-formed, schema-valid, and in Schema Centric Canonical Form (see Schema Centric XML Canonicalization). If it is either not well-formed, not schema-valid, or not in Schema Centric Canonical Form, the behavior of the player cannot be guaranteed and is player-specific. If the player detects that the file is not well-formed, not schema-valid, or not in Schema Centric Canonical Form, the player shall report an error.

The following section specifies the processing of the exemplary rights expressions by AACS HD DVD Pre-recorded players, including the processing relation to the AACS functions of playback, managed copying, and hash checking

A REL Usage Rule including a License and a “MNGCOPY_LICENSES.XML” file in the “AACS” directory can be processed as further described.

In the tables below, the Ordinal column refers to the ordered seven-tuple of members for an authorization request as identified in 5.2 of ISO/IEC 21000-5:2004.

Any EVOBs in a play list may be played back if there is an authorization proof for the authorization request constructed according to Table 3 for playing back those EVOBs.

TABLE 3
Playback authorization request

| Name | Ordinal | Authorization Request Ordered Seven-tuple Values |
|---|---|---|
| Principal | 1 | a bpx:identityHolder of the following form identifying the device performing |
| | | the playback: |
| | | <bpx:identityHolder |
| | | idSystem=“http://www.tbd.org/2005/Device/AACS/HDDVD” |
| | | >EncodedDUNValue</bpx:identityHolder> |
| Right | 2 | mx:play |
| Resource | 3 | an r:digitalResource of the following form identifying the play list: |
| | | <r:digitalResource> |
| | | <r:nonSecureIndirect URI=“PlayListId”/> |
| | | </r:digitalResource> |
| Interval | 4 | the entire interval during which the playback occurs, as further refined in |
| | | exemplary Compliance Rules |
| Context | 5 | the authorization context for the playback, as further refined in exemplary |
| | | Compliance Rules |
| Licenses | 6 | a set of Licenses chosen by the player that shall at least include the Licenses |
| | | indicated in the REL Usage Rules associated with those EVOBs (and may also |
| | | include any Licenses that the player knows about that might apply to this |
| | | request such as licenses previously issued as further described) |
| Trust Root | 7 | a set of r:grant elements with exactly one member, that member of the form |
| | | <r:grant> |
| | | <r:forAll varName=“x”/> |
| | | <bpx:identityHolder |
| | | idSystem=“http://www.tbd.org/2005/Provider/AACS/HDDVD” |
| | | >EncodedProviderId</bpx:identityHolder> |
| | | <r:issue/> |
| | | <r:resource varRef=“x”/> |
| | | </r:grant> |
| | | where the Provider ID is the one from the AACS Content Certificate ID used |
| | | to verify the content. |

If none of the conditions applicable to this authorization request depend on the end of the playback interval, the player shall perform the verification of the proof for this authorization request prior to beginning playback. If any of the conditions applicable to this authorization request depend on the end of the playback interval, the player shall perform the verification of the proof for this authorization request on an incremental periodic basis in such a way that playback is authorized at the time the playback started and that once a playback ceases to be authorized it does not continue for more than 60 seconds beyond the time when it ceases to be authorized.

Sections 4.3.3 and 4.4.3 of AACS HD DVD and DVD Pre-recorded Book specify a content hash check procedure and associated timing constraints. For playback, no change is made to this procedure. The procedure is performed as normal within the associated timing constraints to verify that the content being played back corresponds to the play list and provider identified in the Resource and Trust Root Members, respectively, of the authorization request shown in Table 3.

A resource group defined in a “MNGCOPY_MANIFEST.XML” file in the “AACS” directory may be managed/advanced/clear copied if there is an authorization proof for the authorization request constructed according to Table 4 for that managed/advanced/clear copy operation.

TABLE 4
Managed/advanced/clear copy authorization request

| Name | Ordinal | Authorization Request Ordered Seven-tuple Values |
|---|---|---|
| Principal | 1 | a bpx:identityHolder of the following form identifying the device performing |
| | | the copy: |
| | | <bpx:identityHolder |
| | | idSystem=“http://www.tbd.org/2005/Device/AACS/HDDVD” |
| | | >EncodedDUNValue</bpx:identityHolder> |
| Right | 2 | <bpx:governedCopy governanceRule=“aacs:managedCopy”/> or |
| | | <bpx:governedCopy governanceRule=“bpx:advancedCopy”/> or |
| | | <bpx:governedCopy governanceRule=“bpx:clearCopy”/> |
| Resource | 3 | an r:digitalResource of the following form identifying the resource group: |
| | | <r:digitalResource> |
| | | <r:nonSecureIndirect URI=“ResourceGroupId”/> |
| | | </r:digitalResource> |
| Interval | 4 | the interval of zero length at which the managed/advanced/clear copy is made, |
| | | as further refined in exemplary Compliance Rules |
| Context | 5 | the authorization context for the managed/advanced/clear copy, as further |
| | | refined in exemplary Compliance Rules |
| Licenses | 6 | a set of Licenses chosen by the player that shall at least include all the Licenses |
| | | included in the r:licenseGroup in the “MNGCOPY_LICENSES.XML” file in |
| | | the “AACS” directory. |
| Trust Root | 7 | a set of r:grant elements with exactly one member, that member of the form |
| | | <r:grant> |
| | | <r:forAll varName=“x”/> |
| | | <bpx:identityHolder |
| | | idSystem=“http://www.tbd.org/2005/Provider/AACS/HDDVD” |
| | | >EncodedProviderId</bpx:identityHolder> |
| | | <r:issue/> |
| | | <r:resource varRef=“x”/> |
| | | </r:grant> |
| | | where the Provider ID is the one from the AACS Content Certificate ID used |
| | | to verify the content. |

The player shall perform the verification of the proof for this authorization request prior to making the managed/advanced/clear copy.

Sections 4.3.3 and 4.4.3 of AACS HD DVD and DVD Pre-recorded Book specify a content hash check procedure and associated timing constraints. The timing constraints are not pertinent to making managed/advanced/clear copies. The procedure shall be performed before the managed/advanced/clear copy is made to verify that the content being managed/advanced/clear copied corresponds to the resource group and provider identified in the Resource and Trust Root Members, respectively, of the authorization request shown in Table 4.

A player may include an r:grant in a License it issues if there is an authorization proof for the authorization request constructed according to Table 5 for the inclusion of that r:grant in that License.

TABLE 5
Issue rights authorization request

| Name | Ordinal | Authorization Request Ordered Seven-tuple Values |
|---|---|---|
| Principal | 1 | a bpx:identityHolder of the following form identifying the issuing device: |
| | | <bpx:identityHolder |
| | | idSystem=“http://www.tbd.org/2005/Device/AACS/HDDVD” |
| | | >EncodedDUNValue</bpx:identityHolder> |
| Right | 2 | r:issue |
| Resource | 3 | the r:grant being included in the License |
| Interval | 4 | the interval of zero length at which the r:grant is included in the License, as |
| | | further refined in exemplary Compliance Rules |
| Context | 5 | the authorization context for the inclusion of the r:grant in the License, as |
| | | further refined in exemplary Compliance Rules |
| Licenses | 6 | a set of Licenses chosen by the player that shall at least include a License |
| | | indicated in an REL Usage Rule |
| Trust Root | 7 | a set of r:grant elements with exactly one member, that member of the |
| | | following form |
| | | <r:grant> |
| | | <r:forAll varName=“x”/> |
| | | <bpx:identityHolder |
| | | idSystem=“http://www.tbd.org/2005/Provider/AACS/HDDVD” |
| | | >EncodedProviderId</bpx:identityHolder> |
| | | <r:issue/> |
| | | <r:resource varRef=“x”/> |
| | | </r:grant> |
| | | where the Provider ID is the one from the AACS Content Certificate ID used |
| | | to verify the TUF including the REL Usage Rule. |

The player shall perform the verification of the proof for this authorization request prior to including the r:grant in the License.

The following section describes the interface-specific compliance rules on the authorization context described in exemplary Compliance Rules. The authorization context is a vehicle for forming the link between the rights expression semantics relying on truths and the compliance rules for how the truth is determined. For functionality that relates to the material in this interface book, it is appropriate for the exemplary Compliance Rules to refer to specifications provided by AACS. The goal of this section is to highlight all such reference points so that the exemplary Compliance Rules can simply refer to this section.

The exemplary embodiments assume that the exemplary Compliance Rules include rules about usage of authorization context properties in authorization requests:

Some authorization context properties will have no constraints placed on their use by the exemplary Compliance Rules,

Some authorization context properties will have everything about their use locked down in the exemplary Compliance Rules itself, and

Some authorization context properties shall not be used unless explicitly permitted in the exemplary Interface book.

This section specifies the authorization context property uses permitted by the exemplary interface book.

A player may use an aacs:evobsUrPtr context property in an authorization context in an authorization request if the statement made by that context property is true.

A player may use aacs:pmsn and/or aacs:volumeId context properties in an authorization context in an authorization request if the statements made by those context properties are determined to be true by reading the respective values from the disk in accordance with all AACS compliance and robustness rules about reading and verification of PMSN and Volume Id values.

A player may use a context property named r:issueContext(l, p, h, σ) with value true in an authorization context in an authorization request if all of the following are true:
1. p is a bpx:IdentityHolder and the value of p/@bpx:idSystem is http://www.tbd.org/2005/Provider/AACS/HDDVD,
2. the verification described in 4.4.3 of the AACS HD DVD and DVD Pre-recorded Book succeeds for the file (TUF, ARF, or MNGCOPY_LICENSES.XML) containing l,
3. the Provider ID in the content certificate used in the file verification is the same as the Provider ID in p,
4. there is an l/r:issuer that has exactly one child, and that child is Equal to p,
5. there is an l/r:grant or l/r:grantGroup that is Equal to h, and
6. σ is the empty set.

A player may also use a context property named r:issueContext(l, p, h, σ) with value true in an authorization context in an authorization request if all of the following are true:
1. p is a bpx:IdentityHolder, the value of p/@bpx:idSystem is http://www.tbd.org/2005/Device/AACS/HDDVD, and p identifies the player,
2. there is an l/r:issuer that has exactly one child, and that child is Equal to p,
3. there is an l/r:grant or l/r:grantGroup that is Equal to h, and
4. the player has a exemplary Compliance Rules-robust record that pursuant to Table 5 it included h in l based on an authorization proof for an authorization request using σ as its fifth member.

A player may use a context property named r:issueTime(l, p) with value i in an authorization context in an authorization request if all of the following are true:
1. p is a bpx:IdentityHolder and the value of p/@bpx:idSystem is http://www.tbd.org/2005/Provider/AACS/HDDVD,
2. the verification described in 4.4.3 of the AACS HD DVD and DVD Pre-recorded Book succeeds for the file (TUF, ARF, or MNGCOPY_LICENSES.XML) containing l,
3. the Provider ID in the content certificate used in the file verification is the same as the Provider ID in p, and
4. there is an l/r:issuer that has exactly one child, and that child is Equal to p.

No constraint is placed on i; its determination is left up to the player.

A player may also use a context property named r:issueTime(l, p) with value i in an authorization context in an authorization request if all of the following are true:
1. p is a bpx:IdentityHolder, the value of p/@bpx:idSystem is http://www.tbd.org/2005/Device/AACS/HDDVD, and p identifies the player,
2. there is an l/r:issuer that has exactly one child, and that child is Equal to p, and
3. the player has a exemplary Compliance Rules-robust record that as described it issued l.

No constraint is placed on i; its determination is left up to the player.

The following two functions are added to the AACS object:

IsIssueSupported returns true if the AACS module
supports the issue function. Otherwise, it returns false.

| Parameters | None. | |
|---|---|---|
| Return Value | result of type | The return value is true if the issue function |
| | Boolean | is supported. Otherwise the return value is |
| | | false. |

| | |
|---|---|
| Exceptions | None. |

issue causes the player to attempt to issue a license as described
resembling the license given as the first argument.
The Usage Rule to be included in the authorization request is the Usage
Rule for the currently-playing EVOB at the time the function is called by
the application.

| | | |
|---|---|---|
| Parameters | grant of | This argument specifies the license to be |
| | type | issued. This is a URL, whose length does not |
| | String | exceed 1024 as defined in the HD DVD-Video |
| | | Specification. The file at this URL is an XML |
| | | license file with no issuer. |
| Return Value | result of | The return value is true if the issuance |
| | type | succeeded. Otherwise, the return value is false. |
| | Boolean | |

| | |
|---|---|
| Exceptions | None. |

The following section shows some examples of rights expressions using the exemplary interface-specific extension and the exemplary interface-specific profiles previously defined.

This section demonstrates how to express two of the business models from the exemplary Business Models sections. For these examples, it is assumed that the governance rules for advanced copy permit the copying of exactly the files defined in the resource group being copied (including or excluding the TUF, depending on whether it is listed in the resource group) and that the rights processing for playing, copying, and issuing works in much the same way as it does from disk (though any disk in drive constraints still require the disk to be in the drive, for example). Contrast this to the governance rules for managed copy that still permit the copying of exactly the files defined in the resource group being copied but the use of those copied files is dependant on the associated managed copy technologies.

A consumer acquires an AACS disc with an offer on the disc which allows the consumer to insert the disk into his mobile video player and create an advanced copy of the content on to his mobile video player. For a specified fee, the user is able to play video play list 999 from the advanced copy without the presence of the disk on his mobile video player.

Three grants are involved in this scenario:
1. A grant to allow the consumer to make an advanced copy.
2. A grant to allow the consumer to designate, for a fee, his mobile video player as being able to play video play list 999 without the presence of the disk.
3. A grant to allow the consumer to play video play list 999 without the presence of the disk on this mobile video player.

The first grant is issued by the content provider and shipped on the disk in the “MNGCOPY_LICENSES.XML” file. The second grant is issued by the content provider, shipped on the disk in the TUF, and copied along with the advanced copy. The third grant is issued by the mobile video player at the direction of the application calling the issue( ) API and is stored on the mobile video player.

The first grant is shown in the following License:

```
<r:license sx:profileCompliance=“aacs:enhanced”>
  <r:grant>
    <bpx:governedCopy governanceRule=“bpx:advancedCopy”/>
    <r:digitalResource>
      <r:nonSecureIndirect URI=“urn:provider:theMovie”/>
    </r:digitalResource>
  </r:grant>
  <r:issuer>
    <bpx:identityHolder
      idSystem=“http://www.tbd.org/2005/Provider/AACS/HDDVD”
    >A35D</bpx:identityHolder>
  </r:issuer>
</r:license>
```

The second grant is shown in the following License:

```
<r:license sx:profileCompliance=“aacs:enhanced”>
  <r:grant>
    <r:forAll varName=“oneDevice”>
      <bpx:identityHolderPattern
        idSystem=“http://www.tbd.org/2005/Device/AACS/HDDVD”/>
    </r:forAll>
    <bpx:identityHolder varRef=“oneDevice”/>
    <r:issue/>
    <r:grant>
      <bpx:identityHolder varRef=“oneDevice”/>
      <mx:play/>
      <r:digitalResource>
        <r:nonSecureIndirect URI=“http://www.tbd.org/2005/VPLST/
        AACS/HDDVD/A35D00000001/999”/>
      </r:digitalResource>
    </r:grant>
    <bpx:seekPermission>
      <r:serviceReference>
        <bpx:serviceLocation>
          <bpx:url>http://www.feePaymentServer.com/</bpx:url>
        </bpx:serviceLocation>
        </r:serviceReference>
    </bpx:seekPermission>
  </r:grant>
  <r:issuer>
    <bpx:identityHolder
      idSystem=“http://www.tbd.org/2005/Provider/AACS/HDDVD”
    >A35D</bpx:identityHolder>
  </r:issuer>
</r:license>
```

The third grant is shown in the following License:

```
<r:license sx:profileCompliance=“aacs:basic”>
  <r:grant>
    <bpx:identityHolder
      idSystem=“http://www.tbd.org/2005/Device/AACS/HDDVD”
    >ad8UJQ7jHLmR110pXdhbKQ==</bpx:identityHolder>
    <mx:play/>
    <r:digitalResource>
      <r:nonSecureIndirect URI=“http://www.tbd.org/2005NPLST/AACS/HDDVD/A35D00000001/999”/>
    </r:digitalResource>
  </r:grant>
  <r:issuer>
    <bpx:identityHolder
      idSystem=“http://www.tbd.org/2005/Device/AACS/HDDVD”
    >ad8UJQ7jHLmR110pXdhbKQ==</bpx:identityHolder>
  </r:issuer>
</r:license>
```

A consumer borrows an AACS disc from a friend. There is an advanced copy creation offer that allows the consumer to create an advanced copy for free. The on-disk usage rules only allow video play list 999 to be played in the presence of the disk, but there is also the ability to make new usage rules in the presence of the disk to allow the same player to play video play list 999 for up to one day without the presence of the disk (so he can return the disk to his friend right away, and still play the copy for a day).

Four grants are involved in this scenario:
1. A grant to allow the consumer to make an advanced copy.
2. A grant to allow the consumer to play video play list 999 in the presence of the disk.
3. A grant to allow the consumer to designate, in the presence of the disk, that same player as being able to play video play list 999 without the presence of the disk for up to one day.
4. A grant to allow the consumer to play video play list 999 without the presence of the disk for up to one day on the player that he has designated.

The first grant is issued by the content provider and shipped on the disk in the “MNGCOPY_LICENSES.XML” file. The second and third grants are issued by the content provider, shipped on the disk in the TUF, and copied along with the advanced copy. The fourth grant is issued by the device at the direction of the application calling the issue( ) API and is stored on the device.

The first grant is shown in the following License:

```
<r:license sx:profileCompliance=“aacs:enhanced”>
  <r:grant>
    <bpx:governedCopy governanceRule=“bpx:advancedCopy”/>
    <r:digitalResource>
      <r:nonSecureIndirect URI=“urn:provider:theMovie”/>
    </r:digitalResource>
  </r:grant>
  <r:issuer>
    <bpx:identityHolder
      idSystem=“http://www.tbd.org/2005/ProvidenAACS/HDDVD”
    >A35D</bpx:identityHolder>
  </r:issuer>
</r:license>
```

The second and third grants are shown in the following License:

```
<r:license sx:profileCompliance=“aacs:basic aacs:enhanced”>
  <r:grant>
    <mx:play/>
    <r:digitalResource>
      <r:nonSecureIndirect URI=“http://www.tbd.org/2005/VPLST/AACS/
      HDDVD/A35D00000001/999”/>
    </r:digitalResource>
    <aacs:diskInDrive>
      <aacs:volumeId>HLmR1ad8UJQ7j1dhbK0pXQ==</aacs:volumeId>
    <aacs:diskInDrive>
  </r:grant>
  <r:grant>
    <r:forAll varName=“oneDevice”>
      <bpx:identityHolderPattern
      idSystem=“http://www.tbd.org/2005/Device/AACS/HDDVD”/>
    </r:forAll>
    <r:forAll varName=“oneDay”>
      <sx:validityIntervalDurationPattern>
        <sx:duration>P1D</sx:duration>
      </sx:validityIntervalDurationPattern>
    </r:forAll>
    <bpx:identityHolder varRef=“oneDevice”/>
    <r:issue/>
    <r:grant>
      <bpx:identityHolder varRef=“oneDevice”/>
      <mx:play/>
      <r:digitalResource>
        <r:nonSecureIndirect URI=“http://www.tbd.org/2005/VPLST/
        AACS/HDDVD/A35D00000001/999”/>
      </r:digitalResource>
      <bpx:startCondition>
        <r:validityInterval varRef=“oneDay”/>
      </bpx:startCondition>
    </r:grant>
    <sx:validityIntervalStartsNow>
      <r:validityInterval varRef=“oneDay”/>
    </sx:validityIntervalStartsNow>
  </r:grant>
  <r:issuer>
    <bpx:identityHolder
      idSystem=“http://www.tbd.org/2005/Provider/AACS/HDDVD”
    >A35D</bpx:identityHolder>
  </r:issuer>
</r:license>
```

The fourth grant is shown in the following License:

```
<r:license sx:profileCompliance=“aacs:enhanced”>
  <r:grant>
    <bpx:identityHolder
      idSystem=“http://www.tbd.org/2005/Device/AACS/HDDVD”
    >ad8UJQ7jHLmR110pXdhbKQ==</bpx:identityHolder>
    <mx:play/>
    <r:digitalResource>
      <r:nonSecureIndirect URI=“http://www.tbd.org/2005/VPLST/
      AACS/HDDVD/A35D00000001/999”/>
    </r:digitalResource>
    <bpx:startCondition>
      <r:validityInterval>
        <r:notBefore>2005-08-05T19:03:02</r:notBefore>
        <r:notAfter>2005-08-06T19:03:02</r:notAfter>
      </r:validityInterval>
    </bpx:startCondition>
  </r:grant>
  <r:issuer>
    <bpx:identityHolder
      idSystem=“http://www.tbd.org/2005/Device/AACS/HDDVD”
    >ad8UJQ7jHLmR110pXdhbKQ==</bpx:identityHolder>
  </r:issuer>
</r:license>
```

The following sections specify the exemplary Rights Expression Profile which is a profile common to various applications for expressing rights upon audiovisual content. The exemplary Rights Expression Profile includes a subset of the MPEG REL base profile in PDAM/1 ISO/IEC 21000-5 MPEG-21 REL Profiles, Aug. 19, 2005, and it defines elements for codifying features that are common to all applications that interface with the exemplary embodiments.

The following sections present namespace prefixes and cites normative references used throughout this book. Further sections lists all the elements included in the exemplary Rights Expression Profile, provide the definitions of the extension elements, show a number of example usage scenarios and REL expressions to codify them, and list the extension schema.

For convenience, this profile uses shorthand namespace prefixes when referring to XML elements and types. The actual prefix used is not important as long as the namespace URI is correct. The prefixes used in this profile are given in the following table.

| Prefix | Name | Namespace |
|---|---|---|
| r | REL Core | urn:mpeg:mpeg21:2003:01-REL-R-NS |
| sx | REL Standard | urn:mpeg:mpeg21:2003:01-REL-SX-NS |
| | Extension | |
| mx | REL Multimedia | urn:mpeg:mpeg21:2003:01-REL-MX-NS |
| | Extension | |
| dsig | XML digital | http://www.w3.org/2000/09/xmldsig# |
| | signature core | |
| xenc | XML encryption | http://www.w3.org/2001/04/xmlenc# |
| | core | |
| bpx | REL Base Profile | urn:mpeg:mpeg21:2005:01-REL-BPX-NS |
| | Extension | |

The normative References include:
[1] ISO/IEC 21000-5:2004, Information technology—Multimedia framework (MPEG-21)—Rights Expression Language.
[2] PDAM/1 ISO/IEC 21000-5 MPEG-21 REL Profiles, Aug. 19, 2005.

The following table lists all the elements included in the exemplary Rights Expression Profile. Elements with the r, sx and mx namespace prefixes come from MPEG REL, and those with the bpx namespace prefix are extension elements which are defined in the next section.

| Element/Child Element | Comments |
|---|---|
| r:licenseGroup | This element is the root element of a license |
| r:license | The definition of an r:license is restricted to include the |
| | following elements: r:grant, and r:issuer. |
| r:grant | Each r:grant represents a rights expression. |
| r:issuer | This element indicates which principal issues the |
| | license. |
| @sx:profileCompliance | The @sx:profileCompliance attribute indicates a profile |
| @bpx:licenseType | that the license is compliant to. The value of |
| | malibu:common can be used in a license to indicate |
| | compliance to this profile. |
| | The attribute @bpx:licenseType provides a further |
| | categorization of the license, which is useful in |
| | identifying what elements and attributes the license |
| | may include. |
| r:grant | An r:grant is restricted to include the following child |
| | elements only: r:forAll, r:principal, r:right, r:resource |
| | and r:condition. |
| r:forAll | This element can be left empty to indicate any |
| | principal, right, resource or condition. It can also |
| | include the sx:validityIntervalDurationPattern |
| | element or the bpx:identityHolderPattern element to |
| | specify a validity interval variable or an identity holder |
| | variable, respectively. |
| sx:validityIntervalDurationPattern | This element is used to specify the duration of a |
| | variable validity interval whose starting time is to be |
| | fixed at the time of resolving the variable. |
| bpx:identityHolderPattern | This element restricts an identity holder to a particular |
| | identification system. |
| r:principal | The r:principal element of r:grant is an abstract type |
| | and must be substituted. This profile only supports |
| | bpx:identityHolder. |
| r:right | The r:right element of r:grant is an abstract type and |
| | must be substituted. This profile only supports r:issue, |
| | mx:play, and bpx:governedCopy. |
| r:resource | The r:resource element of r:grant is an abstract type and |
| | must be substituted. The r:digitalResource is the only |
| | supported resource element. |
| r:condition | The r:condition element of r:grant is an abstract type |
| | and must be substituted. Zero or one condition may |
| | appear directly in a grant. If more than one condition is |
| | to be specified conjunctively, then use the |
| | r:allConditions element. |
| | In this profile, only the following condition elements |
| | are supported: r:allConditions, r:validityInterval, |
| | sx:territory, sx:validityIntervalStartsNow, |
| | bpx:seekPermission, bpx:startCondition, and |
| | bpx:outputRegulation. |
| bpx:identifyHolder | This element specifies a principal who is a holder of the |
| | specified identity, possibly in a specified identification |
| | system. |
| bpx:governedCopy | This right allows making a copy of the underlying |
| | resource and issuing rights to the copied resource. |
| @governanceRule | How the copy is made and what rights are going to be |
| | issued for the copy are determined by the governance |
| | rule indicated by the optional attribute |
| | @governanceRule. When the attribute is not specified, |
| | this right allows to make a bit-wise identical copy of |
| | the resource and to result in an identical copy of the |
| | r:license that this right is specified being made to the |
| | copied resource. |
| r:digitalResource | This element specifies a digital resource. This profile |
| | only supports referencing a digital resource using |
| | r:nonSecureIndirect. |
| r:nonSecureIndirect | r:nonSecureIndirect identifies a digital resource by |
| | reference. |
| r:allConditions | The r:allConditions element is retained in the profile, so |
| | that other conditions can be grouped together by it and |
| | used conjunctively. |
| r:condition | Conditions that can substitute this r:condition are |
| | sx:validityInterval, sx:territory, |
| | sx:validityIntervalStartsNow, bpx:seekPermission, |
| | bpx:startCondition, and bpx:outputRegulation. |
| r:validityInterval | This is a specific condition element used to specify a |
| | fixed interval of time. |
| r:notBefore | Starting time of the specified validity interval. |
| r:notAfter | Ending time of the specified validity interval. |
| sx:territory | This is a specific condition element used to specify a |
| | geographic territory or network domain. In this profile, |
| | it only supports specification of country as territory. |
| sx:location | The sx:location/sx:country element is used to specify a |
| sx:country | list of countries. |
| bpx:seekPermission | This condition element requires that permission from a |
| | server be sought before the associated right may be |
| | exercised, and restricts a time period during which an |
| | obtained permission can be cached for future use |
| | without contacting the server.. |
| r:serviceReference | The r:serviceReference identifies the server. |
| bpx:cacheable | The bpx:cacheable specifies a time interval during |
| | which the obtained permission is cached. When |
| | omitted, the obtained permission is not allowed to |
| | cache. |
| bpx:peroid | This element specifies the duration period of the time |
| | interval the obtained permission is allowed to cache. |
| | When omitted, the obtained permission is allowed to |
| | cache indefinitely. |
| bpx:startCondition | This condition element requires that the includeed |
| | condition be checked at the start of an exercise of the |
| | associated right. |
| r:condition | Conditions that can substitute this r:condition are |
| | r:allConditions, r:validityInterval, sx:territory, |
| | sx:validityIntervalStartsNow, and |
| | bpx:outputRegulation. |
| bpx:outputRegulation | This condition element requires that output signal be |
| | regulated using any of the regulations specified by the |
| | list of bpx:regulation elements. |
| bpx:regulation | The optional attribute @typeOfSignal indicates which |
| @typeOfSignal | type, bpx:digital or bpx:analog, of signal the regulation |
| @qualityOfSignal | applies. When this attribute is not present, the |
| | regulation applies to any type. The optional attribute |
| | @qualityOfSignal indicates what quality, bpx:HD (for |
| | high-definition) or bpx:SD (for standard definition), of |
| | the signal the regulation applies. When this attribute is |
| | not present, the regulation applies to any quality of the |
| | signal. |
| r:issuer | This element is restricted to include the r:principal |
| | element only. |
| bpx:identityHolder | This element gives the identity of the issuer. |

This section defines an MPEG REL extension which represents the additional common features supported by the exemplary embodiments. The exemplary Rights Expression Profile draws from this extension. The syntax and the semantics of the extension elements are presented here. The XML schema for the extension elements and types are further listed.

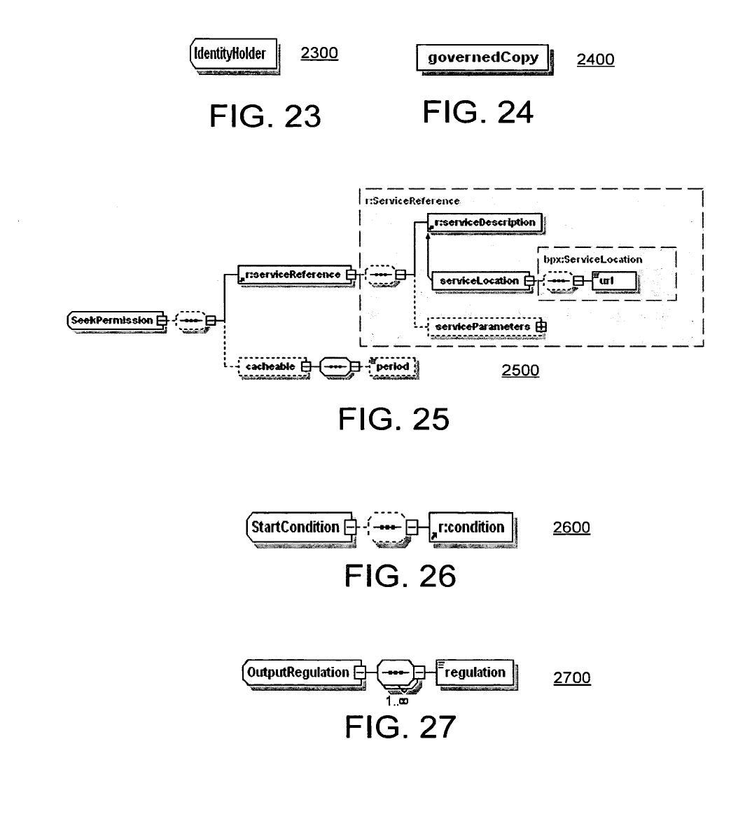

The identityHolder element is an extension of the r:Principal defined in the REL Core. It identifies the principal who is the holder of the specified identity, which can be an unrestricted mixture of character content and element content from any namespace. The optional idSystem attribute can be used to indicate the identification system. FIG. 23 shows the identityHolder Principal.

The following example specifies a principal as the holder of an International Mobile Subscriber Identifier.

```
<r:grant>
  <bpx:identityHolder idSystem=“urn:mpeg:mpeg21:2005:01-
  REL-bpx-NS:imsi”> IMSI:2232111123
</bpx:identityHolder>
  <mx:play/>
  <r:digitalResource>
    <r:nonSecureIndirect URI=“urn:movie:clips:hero_trailer.mpeg”/>
  </r:digitalResource>
</r:grant>
```

In the above example, the bpx:identityHolder is granted the right to play the resource specified in r:digitalResource.

Let p be an r:IdentityHolder. Then p identifies that system entity that possesses the identifier indicated by the value p, and the identifier belongs to the identification system indicated by p/@r:idSystem when the attribute is present.

The GovernedCopy element represents the right to copy the resource and at the same time to result in certain rights being associated to the copied resource. The optional attribute @governanceRule of type QName indicates the name of a governance rule that determines how exactly the copy should be made and what rights should be associated and by whom for the copied resource. When the attribute is not specified, this right allows to make a bit-wise identical copy of the resource and to result in an identical copy of the r:license that this right is specified being made to the copied resource. FIG. 24 shows the governedCopy Right.

Two distinguished governance rules are defined as “bpx:advancedCopy” and “bpx:clearCopy,” as further defined.

A sample code fragment is provided below for illustration:

```
<r:license>
  <r:grant>
    <mx:play/>
    <r:digitalResource>
      <r:nonSecureIndirect URI=“urn:movie:clips:hero_trailer.mpeg”/>
    </r:digitalResource>
  </r:grant>
  <r:grant>
    <bpx:governedCopy/>
    <r:digitalResource>
      <r:nonSecureIndirect URI=“urn:movie:clips:hero_trailer.mpeg”/>
    </r:digitalResource>
  </r:grant>
</r:license>
```

In the above example, any principal is granted the right to play a movie clip, and the right to copy the clip together with the same license.

Following is another example license:

```
<r:license >
  <r:grant>
    <mx:play/>
    <r:digitalResource>
      <r:nonSecureIndirect URI=“urn:movie:clips:hero_trailer.mpeg”/>
    </r:digitalResource>
  </r:grant>
  <r:grant>
    <bpx:governedCopy governanceRule=“acme:CopyOnce”/>
    <r:digitalResource>
      <r:nonSecureIndirect URI=“urn:movie:clips:hero_trailer.mpeg”/>
    </r:digitalResource>
  </r:grant>
  <r:issuer>
    <bpx:identityHolder idSystem=“urn:mpeg:mpeg21:2005:01-REL-bpx-
NS:imsi”>IMSI:2232111123</bpx:identityHolder>
  </r:issuer>
</r:license >
```

Suppose the governance rule named “acme:CopyOnce” only allows exercising this right once to make a bit-wise identical copy of the resource and associating the other rights in the same license to the copied resource by issuing another license by the same issuer. In this case, exercising the right bpx:governedCopy in the license will result in a bit-wise identical copy of the resource, and the following license:

```
<r:license >
  <r:grant>
    <mx:play/>
    <r:digitalResource>
      <r:nonSecureIndirect URI=“urn:movie:clips:hero_trailer.mpeg”/>
    </r:digitalResource>
  </r:grant>
  <r:issuer>
    <bpx:identityHolder idSystem=“urn:mpeg:mpeg21:2005:01-REL-bpx-
NS:imsi”>IMSI:2232111123</bpx:identityHolder>
  </r:issuer>
</r:license >
```

Let r be a bpx:GovernedCopy. Then, if r/@bpx:governanceRule is present, r identifies the act of making a copy and associating right expressions with that copy in compliance with the compliance rules identified by r@bpx:governanceRule. Otherwise, if r/@bpx:governanceRule is absent, r identifies the act of making a bit-wise identical copy and associating a right expression to that copy that is Equal to the License in the authorizer in one of the authorization proofs for the authorization request for that copy.

If r is used as the Right Member of an authorization request, then the Resource Member of that authorization request shall be present and shall identify the resource being copied.

The SeekPermission condition and ServiceLocation elements require that permission from a server be sought before the associated right may be exercised, and restricts a time period during which an obtained permission can be cached for future use without contacting the server. FIG. 25 shows the SeekPermission Condition and ServiceLocation elements.

The r:serviceReference element, when used in the bpx:seekPermission element, describes a reference to a server from which the permission for exercising the associated right must be sought. The bpx:serviceLocation specifies a server by its location bpx:url indicating where the server is located.

The optional bpx:cacheable element is used to indicate that the permission obtained from the server may be cached. Its child element bpx:period indicates the amount of time that the permission may stay in the cache until it must be deleted.

The condition specified by the element is satisfied only when any of the following is true:
1. The element bpx:cacheable is present, and there is a permission in the cache that grants the associated right to be exercised.
2. The element bpx:cacheable is not present, the permission is obtained from the server that grants the associated right to be exercised.

In the following example, the right to play a video object can be exercised only if permission is obtained from the server at “http://www.pi.org/paymentService.”

```
<r:grant>
  <mx:play>
  <r:digitalResource>
    <r:nonSecureIndirect URI=“urn:myPlaylist:evobs:1”/>
  </r:digitalResource>
  <bpx:seekPermission>
    <r:serviceReference>
      <bpx:serviceLocation>
        <bpx:url>http://www.foo.org/paymentService</bpx:url>
      </bpx:serviceLocation>
    </r:serviceReference>
  </bpx:seekPermission>
</r:grant>
```

Let c be a bpx:SeekPermission. Let (p, r, t, v, Σ, L, R) be an authorization request. Let (g, h, e) be an authorization story. Let m be c/r:serviceReference. Then c is Satisfied with respect to (p, r, t, v, Σ, L, R) and (g, h, e) if and only if either m is undefined or, letting Σ be the ordered tuple containing the values of the reference-specific parameters determined by m, at least one of the following is true:

Σ.bpx:sP(m/r:serviceDescription, ρ) is true or
all of the following are true for σ equal to some subset of Σ:
c/bpx:cacheable is present,
Σ.bpx:sPC(m/r:serviceDescription, ρ, p, r, t, σ) exists, and
if c/bpx:cacheable/bpx:period is present then Σ.bpx:sPC(m/r:serviceDescription, ρ, p, r, t, σ) is less than the value of c/bpx:cacheable/bpx:period.

Let d be a bpx:ServiceLocation. Then the description of the service described by d is given in the “General Payment and Permission Protocol” section of the exemplary Protocols Book. The endpoint of the service is given by the value of d/bpx:url.

The StartCondition condition element requires the included condition be checked at the start of an exercise of the associated right. FIG. 26 shows the StartCondition condition element.

The condition is satisfied only if the included condition is satisfied at the starting time of exercising the associated right.

Using this condition to wrap another condition (such as a time condition) makes it possible to satisfy this condition without necessarily knowing how long the requested exercise will last in order to test the wrapped condition and without having to continually check the wrapped condition (which otherwise may be required) as the requested exercise continues to take place.

For example, the following expression specifies that the resource can be played as long as the playing starts within the year of 2005.

```
<r:grant>
  <mx:play>
  <r:digitalResource>
    <r:nonSecureIndirect URI=“urn:myPlaylist:evobs:1”/>
  </r:digitalResource>
  <bpx:startCondition licensePartId=“startIn2005”>
    <r:validityInterval>
      <r:notBefore>2005-01-01T00:00:00</r:notBefore>
      <r:notAfter>2005-12-31T23:59:59</r:notAfter>
    </r:validityInterval>
  </bpx:startCondition>
</r:grant>
```

Let c be a bpx:StartCondition. Let (p, r, t, v, Σ, L, R) be an authorization request. Let (g, h, e) be an authorization story. Then c is Satisfied with respect to (p, r, t, v, Σ, L, R) and (g, h, e) if and only if c/r:condition is Satisfied with respect to (p, r, t, i, Σ, L, R) and (g, h, e) where i is the interval of zero length starting at the start of time interval v.

The OutputRegulation condition element requires output signal to be regulated using any of the regulations specified by the list of bpx:regulation elements. FIG. 27 shows the OutputRegulation condition element.

The optional attribute @typeOfSignal indicates which type, bpx:digital or bpx:analog, of signal the regulation applies. When this attribute is not present, the regulation applies to any type. The optional attribute @qualityOfSignal indicates which quality, bpx:HD (for high-definition) or bpx:SD (for standard definition), of the signal the regulation applies. When this attribute is not present, the regulation applies to any quality of the signal.

This condition is satisfied only if at least one of the regulations specified by the list of bpx:regulations is used to regulate the output signal with a matched type and matched quality. Here, the type of the signal matches with the type of the regulation if the associated bpx:regulations has either no type specified or an identical type, and the quality of the signal matches with the quality of the regulation if the associated bpx:regulation has either no quality specified or an identical quality.

The following example shows that a movie trailer is allowed to play when the output signal is regulated by either allowing High Definition Analog Output in the form of Constrained Image (ICT:1) or having Analogy Protection according to Type 1 of APS (APSTB:01).

```
<r:grant>
  <mx:play/>
  <r:digitalResource>
    <r:nonSecureIndirect URI=“urn:movie:clips:hero_trailer.mpeg”/>
  </r:digitalResource>
  <bpx:outputRegulation>
    <bpx:regulation typeOfSignal=“bpx:analog”qualityOfSignal=“bpx:HD”>ICT:1</bpx:regulation >
    <bpx:regulation typeOfSignal=“bpx:analog”>APSTB:01</bpx:regulation>
  </bpx: outputRegulation >
</r:grant>
```

Let c be a bpx:OutputRegulation. Let (p, r, t, v, Σ, L, R) be an authorization request. Let (g, h, e) be an authorization story. Then c is Satisfied with respect to (p, r, t, v, Σ, L, R) and (g, h, e) if and only if, for every integer i from 1 to Σ.bpx:oRNum( ), there exists a c/bpx:regulation child γ of c such that all of the following are true:

γ/@bpx:typeOfSignal is absent or its value is Equal to Σ.bpx:oRTOS(i),

γ/@bpx:qualityOfSignal is absent or its value is Equal to Σ.bpx:oRQOS(i), and

Σ.bpx:oR(i,the value of γ) is true.

The IdentityHolderPattern element restricts an identity holder to a particular identification system. It defines a pattern that matches a bpx:identityHolder element with a specific bpx:idSystem attribute. It is an extension of the r: PrincipalPatternAbstract defined in the REL Core.

An r:forAll element with an embedded bpx:identityHolder element represents the declaration of a variable whose eligible binding is a set of bpx:identityHolders with a bpx:idSystem attribute matching the bpx:idSystem attribute specified in the pattern.

The following example declares and uses a variable called “authorizedDevice”. Effectively, any holder of an identity issued by the identification system called “urn:mpeg:mpeg21:2005:01-REL-bpx-NS:imsi” may play the specified content.

```
<r:grant>
  <r:forAll varName=“authorizedDevice”>
    <bpx:identityHolderPattern idSystem=“urn:mpeg:mpeg21:2005:01-REL-bpx-NS:imsi”/>
  </r:forAll>
  <bpx:identityHolder varRef=“authorizedDevice”/>
  <mx:play />
  <r:digitalResource>
    <r:nonSecureIndirect URI=“urn:myPlaylist”/>
  </r:digitalResource>
</r:grant>
```

Let a be a bpx:IdentityHolderPattern. Let x be an XML document. Let m be the root element contained in x. Let q be an authorization request. Let e be an authorizer. Then x Matches a with respect to q and e if and only if both m is a bpx:IdentityHolder and the value of m/@bpx:idSystem is equal to the value of a/@bpx:idSystem.

Table 6 specifies the authorization context properties relating to the base profile extension and the statements they represent. If a property has the name given in the first column of Table 6 and the value given in the second column of Table 6, then the statement represented by that property is the statement given in the third column of Table 6.

TABLE 6
Base profile extension authorization context properties

| | Property | |
|---|---|---|
| Property name | value | Statement represented |
| bpx:oR(i, q) | true | i is an integer, q is an xsd:QName, and q identifies one of the output |
| | | regulations applied to the i^{th} output signal used in the requested |
| | | performance. |
| bpx:oRNum | i | i is an integer and i is the total number of output signals used in the |
| | | requested performance. |
| bpx:oRQOS(i) | q | i is an integer, q is an xsd:QName, and q identifies the quality of the |
| | | i^{th} output signal used in the requested performance. |
| bpx:oRTOS(i) | q | i is an integer, q is an xsd:QName, and q identifies the type of the i^{th} |
| | | output signal used in the requested performance. |
| bpx:sP(d, ρ) | true | d is an r:ServiceDescription, ρ is an ordered tuple, and the service |
| | | described by d claims that this property may be used in an |
| | | authorization context to establish permission for the requested |
| | | performance. |
| bpx:sPC(d, ρ, p, r, | δ | d is an r:ServiceDescription, ρ is an ordered tuple, p is an r:Principal, |
| t, σ) | | r is an r:Right, t is an r:Resource, σ is an authorization context, δ is a |
| | | non-negative duration, and there is cache record indicating that the |
| | | service described by d generated an affirmative response with |
| | | respect to ρ, p, r, t, and σ at a time occurring before the start of the |
| | | requested performance by a duration of δ. |

Qualified Names, include profileCompliance QName, which is the qualified name bpx:malibu-common used as the value of @sx:profileCompliance in a license to indicate compliance to this profile; GovernanceRule QNames, include AdvancedCopy, which is the qualified name bpx:AdvancedCopy that identifies the compliance rules specified in the “Advanced Copy” section of the exemplary Compliance Rules, and ClearCopy, which is the qualified name bpx:ClearCopy that identifies the compliance rules specified in the “Clear Copy” section of the exemplary Compliance Rules; Type-of-Signal QNames, include Analog, which is the qualified name bpx:analog that identifies the analog type of signal, and Digital, which is the qualified name bpx:digital that identifies the digital type of signal; Quality-of-Signal QNames, include SD, which is the qualified name bpx:SD that identifies the standard definition quality of signal, and HD, which is the qualified name bpx:HD that identifies the high definition quality of signal; Regulation-of-Signal QNames, include ICT:1, which is the qualified ICT:1name, and APSTB:01, which is the qualified APSTB:01 name

The following section includes exemplary use case scenarios from the exemplary Business Models, and demonstrates the application of the profile defined in the previous sections.

For a fee, the consumer may watch the directors cut version of the film, instead of the theatrical release version (which would be “basic” title).

```
<r:license>
  <r:grant>
    <mx:play/>
    <r:digitalResource>
      <r:nonSecureIndirect URI=“urn:basicTitle”/>
    </r:digitalResource>
  </r:grant>
  <r:grant>
    <mx:play/>
    <r:digitalResource>
      <r:nonSecureIndirect URI=“urn:directorCutVersion”/>
    </r:digitalResource>
    <bpx:seekPermission>
      <r:serviceReference>
        <bpx:serviceLocation>
          <bpx:url>http://www.foo.org/paymentService/
          payPerView</bpx:url>
        </bpx:serviceLocation>
      </r:serviceReference>
    </bpx:seekPermission>
  </r:grant>
</r:license>
```

HBO offers an AACS disk subscription model to customers that choose to receive terrestrial HD television. These customers may not have HBO available to them via cable/satellite. In this case HBO would mail 2 AACS SD disks per month to the customer (30 hours of content per Disk). These disks would have the appropriate months HBO content, but the disks would only be available for the specified month.

The license on the mailed disks will be like the following:

```
<r:license>
  <r:grant>
    <mx:play/>
    <r:digitalResource>
      <r:nonSecureIndirect URI=“urn:myPlaylist”/>
    </r:digitalResource>
    <bpx:startCondition>
      <r:validityInterval>
        <r:notBefore>2005-05-01T00:00:00</r:notBefore>
        <r:notAfter>2005-05-31T23:59:59</r:notAfter>
      </r:validityInterval>
    </bpx:startCondition>
  </r:grant>
</r:license>
```

Consumer acquires a travel book about a particular country. Contained in the book is an AACS disk. The basic title of the disk describes the country, but there is enhanced content that can only be played while in the country.

```
<r:license>
  <r:grant>
    <mx:play/>
    <r:digitalResource>
      <r:nonSecureIndirect URI=“urn:basicTitle”/>
    </r:digitalResource>
  </r:grant>
  <r:grant>
    <mx:play/>
    <r:digitalResource>
      <r:nonSecureIndirect URI=“urn:enhancedTitle”/>
    </r:digitalResource>
    <bpx:startCondition>
      <sx:territory xmlns:iso=“urn:mpeg:mpeg21:2003:01-REL-SX-NS:2003:country”>
        <sx:location>
          <sx:country>iso:US<sx:country>
        </sx:location>
      </sx:territory>
    </bpx:startCondition>
  </r:grant>
</r:license>
```

When content is stored on a server, there is no usage rule on the disk for the content. The download content comes with its usage rules, which means that the rules are not on the disk.

On the other hand, when content is stored on the disk, the usage rule looks like the following:

```
<r:license>
  <r:grant>
    <mx:play/>
    <r:digitalResource>
      <r:nonSecureIndirect URI=“urn:myPlaylist”/>
    </r:digitalResource>
    <bpx:startCondition>
      <r:validityInterval>
        <r:notBefore>2005-05-01T00:00:00</r:notBefore>
      </r:validityInterval>
    </bpx:startCondition>
  </r:grant>
</r:license>
```

When first released, an AACS disk might be a pay per view disk. After a certain time window, the consumer may be permitted to “convert” the disk to a traditional “play from disk” disk.

```
<r:license>
  <r:grant>
    <mx:play/>
    <r:digitalResource>
      <r:nonSecureIndirect URI=“urn:myPlaylist”/>
    </r:digitalResource>
    <r:allConditions>
      <bpx:seekPermission>
        <r:serviceReference>
          <bpx:serviceLocation>
            <bpx:url>http://www.foo.org/paymentService/
            payPerView</bpx:url>
          </bpx:serviceLocation>
        </r:serviceReference>
      </bpx:seekPermission>
      <bpx:startCondition>
        <r:validityInterval>
          <r:notAfter>2005-04-30T23:59:59</r:notAfter>
        </r:validityInterval>
      </bpx:startCondition>
    </r:allConditions>
  </r:grant>
  <r:grant>
    <mx:play/>
    <r:digitalResource>
      <r:nonSecureIndirect URI=“urn:myPlaylist”/>
    </r:digitalResource>
    <bpx:startCondition>
      <r:validityInterval>
        <r:notBefore>2005-05-01T00:00:00</r:notBefore>
      </r:validityInterval>
    </bpx:startCondition>
  </r:grant>
</r:license>
```

Consumer buys a new high resolution display. They then go to a rental shop to rent their favourite movie. They are prevented from viewing the high resolution version for two months because the rental version has limited rights until the end of the year.

```
<r:license>
  <r:grant>
    <mx:play/>
    <r:digitalResource>
      <r:nonSecureIndirect URI=“urn:movieALoRes”/>
    </r:digitalResource>
  </r:grant>
  <r:grant>
    <mx:play/>
    <r:digitalResource>
      <r:nonSecureIndirect URI=“urn:movieAHighRes”/>
    </r:digitalResource>
    <bpx:startCondition>
      <r:validityInterval>
        <r:notBefore>2005-12-01T00:00:00</r:notBefore>
    </r:validityInterval>
  </bpx:startCondition>
  </r:grant>
</r:license>
```

A consumer acquires an AACS disk that allows the 30 second sound clips to be extracted. The consumer then uses their AACS compliant device to extract certain audio segments from the movie into a clear MP3 format. The consumer then uses one of these segments as a ring tone.

```
<r:license>
  <r:grant>
    <bpx:governedCopy/>
    <r:digitalResource>
      <r:nonSecureIndirect URI=“urn:movieASoundClip1”/>
    </r:digitalResource>
  </r:grant>
</r:license>
```

Users who register their movie with WB.com can extract files from the disk like movies, wallpaper, ring tones, etc.

```
<r:license>
  <r:grant>
      <bpx:governedCopy governanceRule=“bpx:clearCopy”/>
      <r:digitalResource>
        <r:nonSecureIndirect URI=“urn:movieARingTone1”/>
      </r:digitalResource>
  </r:grant>
    </r:license>
```

Fixed time, date, either or both:

```
<r:license>
  <r:grant>
    <mx:play/>
    <r:digitalResource>
      <r:nonSecureIndirect URI=“urn:myPlaylist”/>
    </r:digitalResource>
    <bpx:startCondition>
      <r:validityInterval>
        <r:notBefore>2005-05-01T00:00:00</r:notBefore>
        <r:notAfter>2005-05-31T23:59:59</r:notAfter>
      </r:validityInterval>
    </bpx:startCondition>
  </r:grant>
</r:license>
```

Relative to online authorization time:

```
<r:license>
  <r:grant>
    <bpx:governedCopy/>
    <r:digitalResource>
      <r:nonSecureIndirect URI=“urn:myPlaylist”/>
    </r:digitalResource>
    <bpx:seekPermission>
      <r:serviceReference>
        <bpx:serviceLocation>
          <bpx:url>http://www.foo.org/remoteServer</bpx:url>
        </bpx:serviceLocation>
      </r:serviceReference>
      <bpx:cacheable>
        <bpx:period>PT2H</bpx:period>
      </bpx:cacheable>
    </bpx:seekPermission>
  </r:grant>
</r:license>
```

Relative to AC generation time:

```
<r:license>
  <r:grant>
    <r:forAll varName=“oneMonth”>
      <sx:validityIntervalDurationPattern>
        <sx:duration>P1M</sx:duration>
      </sx:validityIntervalDurationPattern>
    </r:forAll>
    <r:issue/>
    <r:grant>
      <mx:play/>
      <r:digitalResource>
        <r:nonSecureIndirect URI=“urn:myPlaylist”/>
      </r:digitalResource>
      <bpx:startCondition>
        <r:validityInterval varRef=“oneMonth”/>
      </bpx:startCondition>
    </r:grant>
    <sx:validityIntervalStartsNow>
      <r:validityInterval varRef=“oneMonth”/>
    </sx:validityIntervalStartsNow>
  </r:grant>
  <r:issuer/>
</r:license>
```

Output Regulated examples, include examples such as must be digital output (no analog), must be protected if HD, and the like, and which is covered by the bpx:outputRegulation condition element. Geographic examples, include examples covered by the r:territory condition element. Payment examples, include examples covered implicitly by the bpx:seekPermission condition element.

Exemplary Schema of the MPEG REL Extension:

```
<xsd:schema targetNamespace=“urn:mpeg:mpeg21:2005:01-REL-BPX-NS”
xmlns:xsd=“http://www.w3.org/2001/XMLSchema” xmlns:sx=“urn:mpeg:mpeg21:2003:01-REL-SX-NS”
xmlns:r=“urn:mpeg:mpeg21:2003:01-REL-R-NS” xmlns:bpx=“urn:mpeg:mpeg21:2005:01-REL-BPX-NS”
elementFormDefault=“qualified” attributeFormDefault=“unqualified”>
  <xsd:import namespace=“http://www.w3.org/XML/1998/namespace”
schemaLocation=“http://www.w3.org/2001/xml.xsd”/>
  <xsd:import namespace=“urn:mpeg:mpeg21:2003:01-REL-R-NS” schemaLocation=“rel-r-bpx-v1.xsd”/>
  <xsd:import namespace=“urn:mpeg:mpeg21:2003:01-REL-SX-NS” schemaLocation=“rel-sx-bpx-v1.xsd”/>
  <xsd:import namespace=“urn:mpeg:mpeg21:2003:01-REL-MX-NS” schemaLocation=“rel-mx-bpx-v1.xsd”/>
  <xsd:element name=“governedCopy” type=“bpx:GovernedCopy” substitutionGroup=“r:right”/>
  <xsd:element name=“seekPermission” type=“bpx:SeekPermission” substitutionGroup=“r:condition”/>
  <xsd:element name=“serviceLocation” type=“bpx:ServiceLocation” substitutionGroup=“r:service
  Description”/>
  <xsd:element name=“startCondition” type=“bpx:StartCondition” substitutionGroup=“r:condition”/>
  <xsd:element name=“outputRegulation” type=“bpx:OutputRegulation” substitutionGroup=“r:condition”/>
  <xsd:element name=“identityHolder” type=“bpx:IdentityHolder” substitutionGroup=“r:principal”/>
  <xsd:element name=“identityHolderPattern” type=“bpx:IdentityHolderPattern”
substitutionGroup=“r:principalPatternAbstract”/>
  <xsd:complexType name=“GovernedCopy”>
    <xsd:complexContent>
      <xsd:extension base=“r:Right”>
        <xsd:attribute name=“governanceRule” type=“xsd:QName”/>
      </xsd:extension>
    </xsd:complexContent>
  </xsd:complexType>
  <xsd:complexType name=“SeekPermission”>
    <xsd:complexContent>
      <xsd:extension base=“r:Condition”>
        <xsd:sequence minOccurs=“0”>
          <xsd:element ref=“r:serviceReference”/>
          <xsd:element name=“cacheable” minOccurs=“0”>
            <xsd:complexType>
              <xsd:sequence>
                <xsd:element name=“period” type=“xsd:duration” minOccurs=“0”/>
              </xsd:sequence>
            </xsd:complexType>
          </xsd:element>
        </xsd:sequence>
      </xsd:extension>
    </xsd:complexContent>
  </xsd:complexType>
  <xsd:complexType name=“ServiceLocation”>
    <xsd:complexContent>
      <xsd:extension base=“r: ServiceDescription”>
        <xsd:sequence minOccurs=“0”>
          <xsd:element name=“url” type=“xsd:anyURI”/>
        </xsd:sequence>
      </xsd:extension>
    </xsd:complexContent>
  </xsd:complexType>
  <xsd:complexType name=“StartCondition”>
    <xsd:complexContent>
      <xsd:extension base=“r:Condition”>
        <xsd:sequence minOccurs=“0”>
          <xsd:element ref=“r:condition”/>
        </xsd:sequence>
      </xsd:extension>
    </xsd:complexContent>
  </xsd:complexType>
  <xsd:complexType name=“OutputRegulation”>
    <xsd:complexContent>
      <xsd:extension base=“r:Condition”>
        <xsd:sequence minOccurs=“0” maxOccurs=“unbounded”>
          <xsd:element name=“regulation”>
            <xsd:complexType>
              <xsd:simpleContent>
                <xsd:extension base=“xsd:QName”>
                  <xsd:attribute name=“typeOfSignal” type=“xsd:QName”/>
                  <xsd:attribute name=“qualityOfSignal” type=“xsd:QName”/>
                </xsd:extension>
              </xsd:simpleContent>
            </xsd:complexType>
          </xsd:element>
        </xsd:sequence>
      </xsd:extension>
    </xsd:complexContent>
  </xsd:complexType>
  <xsd:complexType name=“IdentityHolder” mixed=“true”>
    <xsd:complexContent mixed=“true”>
      <xsd:extension base=“r:Principal”>
      <xsd:attribute name=“idSystem” type=“xsd:anyURI” use=“optional”/>
      </xsd:extension>
    </xsd:complexContent>
  </xsd:complexType>
  <xsd:complexType name=“IdentityHolderPattern”>
    <xsd:complexContent>
      <xsd:extension base=“r:PrincipalPatternAbstract”>
        <xsd:attribute name=“idSystem” type=“xsd:anyURI”/>
      </xsd:extension>
    </xsd:complexContent>
  </xsd:complexType>
</xsd:schema>
```

Exemplary Profile Schema of the MPEG REL Core:

```
<?xml version=“1.0” encoding=“UTF-8”?>
<xsd:schema targetNamespace=“urn:mpeg:mpeg21:2003:01-REL-R-NS”
xmlns:dsig=“http://www.w3.org/2000/09/xmldsig#” xmlns:r=“urn:mpeg:mpeg21:2003:01-REL-R-NS”
xmlns:sccns=“urn:uddi-org:schemaCentricC14N:2002-07-10” xmlns:xsd=“http://www.w3.org/2001/
XMLSchema”
elementFormDefault=“qualified” attributeFormDefault=“unqualified”>
  <xsd:import namespace=“http://www.w3.org/XML/1998/namespace”
schemaLocation=“http://www.w3.org/2001/xml.xsd”/>
  <xsd:import namespace=“http://www.w3.org/2000/09/xmldsig#”
schemaLocation=“http://www.w3.org/TR/2002/REC-xmldsig-core-20020212/xmldsig-core-schema.xsd”/>
  <!-- Elements -->
  <xsd:element name=“allConditions” type=“r:AllConditions” substitutionGroup=“r:condition”/>
  <xsd:element name=“anXmlPatternAbstract” type=“r:AnXmlPatternAbstract” substitutionGroup=
  “r:resource”/>
  <xsd:element name=“condition” type=“r:Condition” substitutionGroup=“r:licensePart”/>
  <xsd:element name=“conditionPatternAbstract” type=“r:ConditionPatternAbstract”
substitutionGroup=“r:anXmlPatternAbstract”/>
  <xsd:element name=“digitalResource” type=“r:DigitalResource” substitutionGroup=“r:resource”/>
  <xsd:element name=“forAll” block=“#all” substitutionGroup=“r:licensePart” final=“#all”>
    <xsd:complexType>
      <xsd:complexContent>
        <xsd:extension base=“r:LicensePart”>
          <xsd:sequence>
            <xsd:element ref=“r:anXmlPatternAbstract” minOccurs=“0” maxOccurs=“unbounded”/>
          </xsd:sequence>
          <xsd:attribute name=“varName” type=“r:VariableName”/>
        </xsd:extension>
      </xsd:complexContent>
    </xsd:complexType>
  </xsd:element>
  <xsd:element name=“grant” type=“r:Grant” substitutionGroup=“r:resource”/>
  <xsd:element name=“issue” block=“#all” substitutionGroup=“r:right” final=“#all”>
    <xsd:complexType>
      <xsd:complexContent>
        <xsd:extension base=“r:Right”/>
      </xsd:complexContent>
    </xsd:complexType>
  </xsd:element>
  <xsd:element name=“issuer” type=“r:Issuer”/>
  <xsd:element name=“license” type=“r:License”/>
  <xsd:element name=“licenseGroup” type=“r:LicenseGroup”/>
  <xsd:element name=“licensePart” type=“r:LicensePart”/>
  <xsd:element name=“principal” type=“r:Principal” substitutionGroup=“r:resource”/>
  <xsd:element name=“principalPatternAbstract” type=“r:PrincipalPatternAbstract”
substitutionGroup=“r:anXmlPatternAbstract”/>
  <xsd:element name=“resource” type=“r:Resource” substitutionGroup=“r:licensePart”/>
  <xsd:element name=“right” type=“r:Right” substitutionGroup=“r:licensePart”/>
  <xsd:element name=“serviceDescription” type=“r:ServiceDescription” substitutionGroup=
  “r:licensePart”/>
  <xsd:element name=“serviceReference” type=“r:ServiceReference” substitutionGroup=“r:resource”/>
  <xsd:element name=“validityInterval” type=“r:ValidityInterval” substitutionGroup=“r:condition”/>
  <!--Complex Types-->
  <xsd:complexType name=“AllConditions”>
    <xsd:complexContent>
      <xsd:extension base=“r: Condition”>
        <xsd:sequence>
          <xsd:element ref=“r:condition” minOccurs=“0” maxOccurs=“unbounded”/>
        </xsd:sequence>
      </xsd:extension>
    </xsd:complexContent>
  </xsd:complexType>
  <xsd:complexType name=“AnXmlPatternAbstract”>
    <xsd:complexContent>
      <xsd:extension base=“r:Resource”/>
    </xsd:complexContent>
  </xsd:complexType>
  <xsd:complexType name=“Condition”>
    <xsd:complexContent>
      <xsd:extension base=“r:LicensePart”/>
    </xsd:complexContent>
  </xsd:complexType>
  <xsd:complexType name=“ConditionPatternAbstract”>
    <xsd:complexContent>
      <xsd:extension base=“r:AnXmlPatternAbstract”/>
    </xsd:complexContent>
  </xsd:complexType>
  <xsd:complexType name=“DigitalResource”>
    <xsd:complexContent>
      <xsd:extension base=“r:Resource”>
        <xsd:choice minOccurs=“0”>
          <xsd:element name=“secureIndirect” type=“dsig:ReferenceType”/>
          <xsd:element name=“nonSecureIndirect” type=“r:NonSecureReference”/>
        </xsd:choice>
      </xsd:extension>
    </xsd:complexContent>
  </xsd:complexType>
  <xsd:complexType name=“Grant”>
    <xsd:complexContent>
      <xsd:extension base=“r:Resource”>
        <xsd:choice minOccurs=“0”>
          <xsd:sequence>
            <xsd:element ref=“r:forAll” minOccurs=“0” maxOccurs=“unbounded”/>
            <xsd:element ref=“r:principal” minOccurs=“0”/>
            <xsd:element ref=“r:right”>/
            <xsd:element ref=“r:resource” minOccurs=“0”/>
          <xsd:element ref=“r:condition” minOccurs=“0”/>
          </xsd:sequence>
        </xsd:choice>
      </xsd:extension>
    </xsd:complexContent>
  </xsd:complexType>
  <xsd:complexType name=“Issuer”>
    <xsd:sequence>
      <xsd:choice minOccurs=“0”>
        <xsd:element ref=“r:principal”/>
      </xsd:choice>
    </xsd:sequence>
  </xsd:complexType>
  <xsd:complexType name=“License”>
    <xsd:choice>
      <xsd:sequence>
        <xsd:choice minOccurs=“0” maxOccurs=“unbounded”>
          <xsd:element ref=“r:grant”/>
        </xsd:choice>
        <xsd:element ref=“r:issuer” minOccurs=“0” maxOccurs=“unbounded”/>
      </xsd:sequence>
    </xsd:choice>
    <xsd:attribute name=“licenseId” type=“xsd:anyURI” use=“optional”/>
    <xsd:anyAttribute namespace=“##other” processContents=“lax”/>
  </xsd:complexType>
  <xsd:complexType name=“LicenseGroup”>
    <xsd:sequence>
      <xsd:element ref=“r:license” minOccurs=“0” maxOccurs=“unbounded”/>
    </xsd:sequence>
  </xsd:complexType>
  <xsd:complexType name=“LicensePart”>
    <xsd:attribute name=“licensePartId” type=“r:LicensePartId” use=“optional”/>
    <xsd:attribute name=“licensePartIdRef” type=“r:LicensePartId” use=“optional”/>
    <xsd:attribute name=“varRef” type=“r:VariableName” use=“optional”/>
  </xsd:complexType>
  <xsd:complexType name=“NonSecureReference”>
    <xsd:attribute name=“URI” type=“xsd:anyURI”/>
  </xsd:complexType>
  <xsd:complexType name=“Principal”>
    <xsd:complexContent>
      <xsd:extension base=“r:Resource”/>
    </xsd:complexContent>
  </xsd:complexType>
  <xsd:complexType name=“Right”>
    <xsd:complexContent>
      <xsd:extension base=“r:LicensePart”/>
    </xsd:complexContent>
  </xsd:complexType>
  <xsd:complexType name=“PrincipalPatternAbstract”>
    <xsd:complexContent>
      <xsd:extension base=“r:AnXmlPatternAbstract”/>
    </xsd:complexContent>
  </xsd:complexType>
  <xsd:complexType name=“Resource”>
    <xsd:complexContent>
      <xsd:extension base=“r:LicensePart”/>
    </xsd:complexContent>
  </xsd:complexType>
  <xsd:complexType name=“ServiceDescription”>
    <xsd:complexContent>
      <xsd:extension base=“r:LicensePart”/>
    </xsd:complexContent>
  </xsd:complexType>
  <xsd:complexType name=“ServiceReference”>
    <xsd:complexContent>
      <xsd:extension base=“r:Resource”>
        <xsd:sequence minOccurs=“0”>
          <xsd:element ref=“r:serviceDescription”/>
        </xsd:sequence>
      </xsd:extension>
    </xsd:complexContent>
  </xsd:complexType>
  <xsd:complexType name>“ValidityInterval”>
    <xsd:complexContent>
      <xsd:extension base=“r:Condition”>
        <xsd:sequence>
          <xsd:element name=“notBefore” type=“xsd:dateTime” minOccurs=“0”/>
            <xsd:element name=“notAfter” type=“xsd:dateTime” minOccurs=“0”/>
          </xsd:sequence>
        </xsd:extension>
      </xsd:complexContent>
    </xsd:complexType>
    <!-- Simple Types-->
    <xsd:simpleType name=“LicensePartId”>
      <xsd:restriction base=“xsd:NCName”/>
    </xsd:simpleType>
    <xsd:simpleType name=“VariableName”>
      <xsd:restriction base=“xsd:NCName”/>
    </xsd:simpleType>
  </xsd:schema>
```

Exemplary Profile Schema of the MPEG REL Standard Extension:

```
<?xml version=“1.0” encoding=“UTF-8”?>
<xsd:schema targetNamespace=“urn:mpeg:mpeg21:2003:01-REL-SX-NS” xmlns:sx=“urn:mpeg:mpeg21:2003:
01-REL-SX-NS” xmlns:r=“urn:mpeg:mpeg21:2003:01-REL-R-NS”
xmlns:dsig=“http://www.w3.org/2000/09/xmldsig#” xmlns:xsd=“http://www.w3.org/2001/XMLSchema”
elementFormDefault=“qualified” attributeFormDefault=“unqualified”>
  <xsd:import namespace=“urn:mpeg:mpeg21:2003:01-REL-R-NS” schemaLocation=“rel-r-bpx-v1.xsd”/>
  <xsd:import namespace=“http://www.w3.org/2000/09/xmldsig#”
schemaLocation=“http://www.w3.org/TR/2002/REC-xmldsig-core-20020212/xmldsig-core-schema.xsd”/>
  <!-- Elements -->
  <xsd:element name=“territory” type=“sx:Territory” substitutionGroup=“r:condition”/>
  <xsd:element name=“validityIntervalDurationPattern” type=“sx:ValidityIntervalDurationPattern”
substitutionGroup=“r:conditionPatternAbstract”/>
  <xsd:element name=“validityIntervalStartsNow” type=“sx:ValidityIntervalStartsNow”
substitutionGroup=“r:condition”/>
  <!--Complex Types-->
  <xsd:complexType name=“Territory”>
    <xsd:complexContent>
      <xsd:extension base=“r:Condition”>
        <xsd:choice minOccurs=“0” maxOccurs=“unbounded”>
          <xsd:element name=“location”>
            <xsd:complexType>
              <xsd:sequence>
                <xsd:element name=“country” type=“xsd:QName” minOccurs=“0”/>
              </xsd:sequence>
            </xsd:complexType>
          </xsd:element>
        </xsd:choice>
      </xsd:extension>
    </xsd:complexContent>
  </xsd:complexType>
  <xsd:complexType name=“ValidityIntervalDurationPattern”>
    <xsd:complexContent>
      <xsd:extension base=“r:ConditionPatternAbstract”>
        <xsd:sequence minOccurs=“0”>
          <xsd:element name=“duration” type=“xsd: duration”/>
        </xsd:sequence>
      </xsd:extension>
    </xsd:complexContent>
  </xsd:complexType>
  <xsd:complexType name=“ValidityIntervalStartsNow”>
    <xsd:complexContent>
      <xsd:extension base=“r:Condition”>
        <xsd:sequence minOccurs=“0”>
          <xsd:element ref=“r:validityInterval”/>
          <xsd:element name=“backwardTolerance” type=“xsd:duration” minOccurs=“0”/>
          <xsd:element name=“forwardTolerance” type=“xsd:duration” minOccurs=“0”/>
        </xsd:sequence>
      </xsd:extension>
    </xsd:complexContent>
  </xsd:complexType>
  <!-- Simple Types -->
  <xsd:simpleType name=“ProfileCompliance”>
    <xsd:list itemType=“xsd:QName”/>
  </xsd:simpleType>
  <!-- Attributes -->
  <xsd:attribute name=“profileCompliance” type=“sx:ProfileCompliance”/>
</xsd:schema>
```

Exemplary Profile Schema of the MPEG REL Multimedia Extension:

```
<?xml version=“1.0” encoding=“UTF-8”?>
<xsd:schema targetNamespace=“urn:mpeg:mpeg21:2003:01-REL-MX-NS”
xmlns:xsd=“http://www.w3.org/2001/XMLSchema” xmlns:r=“urn:mpeg:mpeg21:2003:01-REL-R-NS”
xmlns:mx=“urn:mpeg:mpeg21:2003:01-REL-MX-NS” elementFormDefault=“qualified”
attributeFormDefault=“unqualified”>
  <xsd:import namespace=“urn:mpeg:mpeg21:2003:01-REL-R-NS” schemaLocation=“rel-r-bpx-v1.xsd”/>
  <xsd:import namespace=“urn:mpeg:mpeg21:2003:01-REL-SX-NS” schemaLocation=“rel-sx-bpx-v1.xsd”/>
  <xsd:import namespace=“http://www.w3.org/2001/04/xmlenc#”
schemaLocation=“http://www.w3.org/TR/2002/REC-xmlenc-core-20021210/xenc-schema.xsd”/>
  <!-- Rights -->
  <xsd:element name=“play” type=“mx:Play” substitutionGroup=“r:right”/>
  <!--Complex Types-->
  <xsd:complexType name=“Play”>
    <xsd:complexContent>
      <xsd:extension base=“r:Right”/>
    </xsd:complexContent>
  </xsd:complexType>
</xsd:schema>
```

The following sections capture the target business models that can be supported by the exemplary embodiments. An objective of the exemplary embodiments is to deliver a set of specifications and REL licenses, for example, for the mastering of HD DVD disks by Warner Brothers, and the like.

This section together with the exemplary Architecture Scope and Assumptions section define the exemplary scope of the exemplary embodiments. Further sections enumerate business models and provide examples, and enumerate supported conditions that can be used as part of some of the business models or to enhance them.

Business models are grouped into four basic categories, based on the location of the content:

If content remains on the disk, and the local system is used to govern the usage of the content from the disk, it is considered “Enhanced Mode Content (Content Used While on Disk)”

If the content is delivered from a server and used in support of the disk, it is considered “Enhanced Mode Content (Content Downloaded and Used with Disk)”

If the local system is used to authorize the ability to copy content from the disk, and govern the use of the copied content, it is considered “Advanced Copy Content (Content Copied from Disk)”

If the content is protected on the disk but under certain conditions the content is released from the disk without further mandated usage restrictions, it is considered “Advanced Copy Content (Content Copied from Disk into the Clear)”

In Enhanced Mode Content (Content Used While on Disk) set of models, a player system is used to govern the use of content while it is still on the disk. Because AACS mandates Basic Mode Content be playable by all AACS compliant devices without condition, this section targets the “AACS Enhanced Mode Content.” The intent is to not only provide the basic capabilities of the business models, but also to superimpose the variety of conditions provided in the conditions section.

Pay at the Time of Consumption includes Enhanced mode content that cannot be played without paying a fee.

Example:

For a fee, the consumer may watch the directors cut version of the film, instead of the theatrical release version (which would be “basic” title).

Example:

A consumer receives a free copy of a movie disk at a convenience store. The disk would include the full movie, and trailers for the included movie as well as others. If the user wishes to view the full movie, they could pay a fee that would authorize playback. The disk could then be handed to a friend, etc.

In this case the main movie title would be flagged “enhanced” while the trailer for the movie and the terms and conditions would be flagged “basic.”

Example:

15 SD (Standard Definition) resolution movies are available on the disk. None of the movies are viewable without a financial transaction.

Time Release Subscription includes delivering disks to consumers based on a subscription model. These disks will work for the appropriate unit of time (e.g., Month of May '06).

Example:

HBO offers a disk subscription to customers that choose to receive terrestrial HD television. These customers may not have HBO available to them via cable/satellite. In this case, HBO would mail 2 SD disks per month to the customer (30 hours of content per Disk). These disks would have the appropriate months HBO content, but the disks would only be usable for the specified month.

Example:

As above, only some content unlocks on a specific day of the month to coincide with the premiere dates that occur on the subscription month. For example, episode 201 of Band of Brothers is only available after May 13th, when it premiers on HBO.

Locked Content includes a disk that has locked content that can only be accessed under certain conditions (e.g., online transaction).

Example:

Consumer acquires a travel book about a particular country. Contained in the book is a disk. The basic title of the disk describes the country, but there is enhanced content that can only be played while in the country.

Pre Purchase includes a consumer that acquires a disk that has content on it that will only be usable after a certain date.

Example:

Special disks could be made available for purchase at theaters during the theatrical release of a movie. These disks would not be usable until the retail release of the movie. The price of these disks could be the same price as the retail disks, but include special content, or they could be priced lower than the retail disks. The consumer would have a compelling reason to attend the theatrical release instead of waiting to purchase the HD DVD.

Time Released Conditions include usage rules that are expanded over time.

Example:

When first released, a disk might be a pay per view disk. After a certain time window, the consumer may be permitted to “convert” the disk to a traditional “play from disk” disk.

Example:

Consumer buys a new high resolution display. They then go to a rental shop to rent their favourite movie. They are prevented from viewing the high resolution version for two months because the rental version has limited rights until the end of the year.

As far as security concerns, the disk might or might not have the actual movie content. The disk might include only promotions and playlists for acquiring the movie as download content closer to the release window.

The following Enhanced Mode Content (Content Downloaded and Used with Disk) models, include additional content being made available online to use with the disk. This additional content may have various conditions placed on the ability to play it (e.g., geographic, time, fee, etc.).

Streaming Content includes online content can being streamed from a service for use in conjunction with the disk.

Example:

A consumer acquires a disk with the option to have an audio commentary from an actor in the movie played in sync with the movie. This commentary is not a replacement sound track, but an additional track played with the rest of the movie.

Downloaded Content includes online content that can be delivered and stored for use in conjunction with the disk.

Example:

A consumer identifies additional subtitle material is available for use with a movie. They download the subtitles and store it on their compliant device, but the subtitles are not usable unless they are used with the associated disk. The consumer then rents the disk and views the subtitles during the movie playback.

Advanced Copy (AC) Content (Content Copied from Disk) includes an exemplary version of a copy. The AC model does not preclude or interfere in any way with the “AACS Managed Copy” (MC). The AC feature is optional for device implementers and built on top of AACS.

The primary difference between an AC and an MC is that the usage of an AC is determined by “Usage Rules” that are both flexible and can vary on a title-by-title basis while the usage of an MC is determined by the AACS specifications and compliance rules, which are fixed across all content types.

Usage rules are specified that control two aspects of an AC. The first are rules that govern under which conditions an AC can be created. The rules for creating an AC can be very sophisticated, and include many parameters, including such things as: fees, geographical restrictions, memberships, target DRM Systems, dates, resolutions, and tracking, etc.

The second aspect is the actual usage of an AC. After an AC is created, usage rules are associated to govern the usage of the AC. These rules can also be very sophisticated and include similar types of parameters as the rules for authorizing the creation of the AC.

Example:

A disk may include a main title movie, with permission to create a MC for a fee of $5. The consumer could create an MC in accordance with AACS compliance or . . . .

If the consumer owned a device compliant with the exemplary embodiments they may also see an offer for an AC. This offer may state that they have the ability to create an AC for free, but the AC is locked to the receiving DRM system, and requires $3 each time to play it.

Bind to Device inclused content that can be copied from the disk, but can only be played in the presence of an identified device after the copy is created.

Example:

A consumer acquires a disk with an offer which allows the consumer to create a copy of the content onto his/her player's protected storage. Creating the AC could have usage rules associated with it (e.g., a fee), and the AC would have usage rules associated with it (e.g., only playable by this particular player).

Example:

A consumer borrows a disk from a friend. There is an AC creation offer that allows the consumer to create an AC for free, with the condition that it is only usable for 1 day after the AC is created, and only by the target device.

Superdistribution includes copies of the disk content that are permitted to be distributed directly between a customer and his/her friends. A distributed version of the content might not be usable without additional permissions or usage rules being granted from a server.

Example:

A consumer borrows a disk from a friend. The disk permits the creation of an AC. The creation of the AC could be for free, but the AC content would be unusable until a $15 fee is paid. At the time the fee is paid, the AC content could then be playable indefinitely by the associated device.

Example:

As in the above example, except the consumer uses his/her broadband connection to send a copy of the movie to his/her friend. In this case, the AC creation offer could be contingent on identifying the target device at creation time. In this manner, the consumer could push a copy of the movie to a friend, and the friend could opt to pay for the movie without having to get the disk.

Advanced Copy Content (Content Copied from Disk into the Clear) includes an assumption that disks include either clear content or content protected by AACS, and that the AACS compliance rules govern the use of AACS protected content after it has been unlocked by AACS.

These models provide an additional mode where the content can be protected by AACS until certain conditions are met and then released into the clear. The content is presumed to be either inherently protected by some other means (e.g., game copy protection) or released into a clear format (e.g., mp3, jpg, etc.).

Example:

The disk includes non theatrical material for purchase. For a fee the user can unlock an XBox game related to the movie.

Example:

Users who register their movie with WB.com can copy files from the disk like movies, wallpaper, ring tones, etc.

In general, conditions are specified circumstances that must be met in order for a complaint system to act. Whereas usage rules govern when and how content can be played or released to another DRM system, conditions on these actions help to build particular business models. Here are some examples:

A per use fee condition placed on the ability to play enhanced content builds a pay per view model.

A time condition placed on the ability to play enhanced content can be used to implement a rental model or pre purchase model.

A fee condition placed on the ability to create a copy can be used to implement a form of Superdistribution.

A fee condition placed on the ability to use a copy implements a different flavor of Superdistribution. In this case creating the copy may have been free, while using the copy incurs a fee.

This section describes the targeted types of conditions for the Exemplary business models.

Time Constraint includes the ability to use or distribute content that may be governed by some time constraints.

Examples:

Fixed time, date, either or both

Start time

End time

Relative to online authorization time

Relative to AC generation time

Output Regulated includes when content is used that there may be restrictions on the types of ports that can be used to deliver the content to various rendering devices.

Examples:

Must be digital output (no analog)

Must be protected if HD

Geographic includes the usage of the content that could be restricted to certain geographical areas.

Examples:

Country

Payment includes content that can be used when a payment is made.

Examples:

Per use fee—a fee is required each time the content is played.

Flat fee—a one-time fee is required for using the content.

The following sections capture the architecture scope intended to be supported for the exemplary embodiments and some assumptions and issues upon which the scope relies. An objective of the exemplary embodiments is to deliver a set of specifications and REL licenses, for example, for the mastering of HD DVD discs by Warner Brothers.

The following sections, together with the Exemplary business models, define the scope of the exemplary embodiments.

The architecture scope is to support the business models described in the Exemplary business models and the requirements specified in the AACS Common Book for the title usage file (TUF).

The remaining sections describe the exempalry system components, a number of the architectural scenarios that the exemplary embodiments support, list exemplary embodiments related to Technical Compliance Rules.

This section describes the exemplary system components, which include:

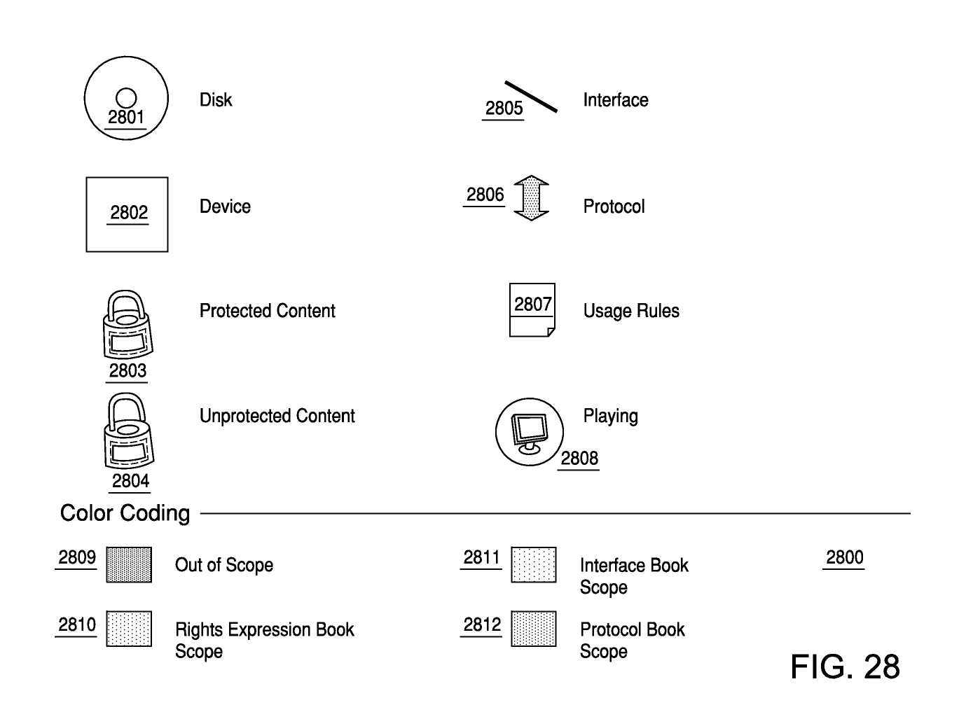

FIG. 28: A key defining the graphical representations used for the system components.

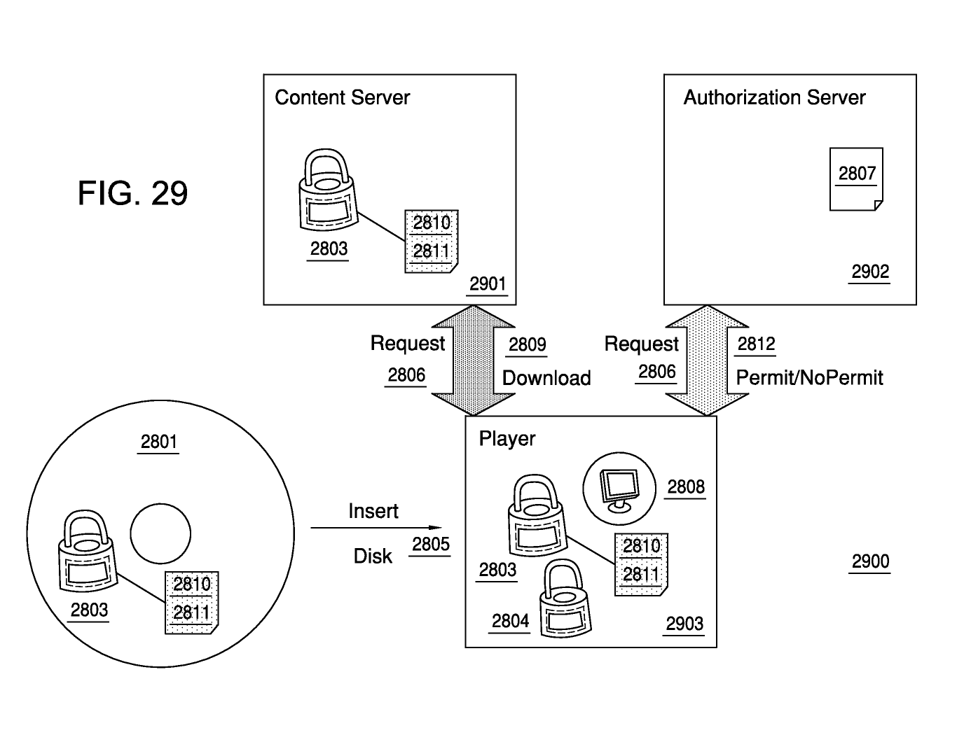

FIG. 29: A diagram illustrating how the basic exemplary components are combined to form four system components: a disk, a player, a content server, and an authorization server. This diagram also illustrates the interactions between the four system components.

Accordingly, the exemplary system components diagram 2900 of FIG. 29 uses the graphical representations 2800 defined in FIG. 28, including disks 2801, devices 2802, protected content 2803, unprotected content 2804, interfaces 2805, protocols 2806, usage rules or rights 2807, playing elements 2808, out of scope designations 2809, rights expression book scope designations 2810, interface book scope designations 2811, and protocol book scope designations 2812.

The exemplary system 2900 of FIG. 29 includes the system components 2801-2812 illustrated above:

A Disk 2801: This component includes an AACS HD DVD pre-recorded disk (recordable disks are not considered) that includes protected content governed by usage rules written according to the exemplary Rights Expression Book and the exemplary Interface Book. The exemplary Interface Book also defines the exact nature of the binding between the protected content and the usage rules.

A Player 2903: This component is capable of exercising rights to use and possibly distribute the protected content encoded on the disk 2801.

A Content Server 2901: This component is a server that provides ancillary protected content or TUFs to a requesting player 2903. Downloading content or TUFs from the content server 2901 enables the player 2903 to obtain content or usage rules in addition to those stored on the disk 2801.

An Authorization Server 2902: This component authorizes a requested exercise of rights for a requesting player 2903. Determining the appropriate authorization response may involve interpreting usage rules 2807 stored on the server 2902, receiving or verifying payment, or other authorization processing. Any usage rules 2807 stored on the authorization server 2902 are communicated to it out of band.

It is expected that a few content and authorization servers 2902 will communicate with many players 2903.

No separate service need exist purely for the purpose of issuing licenses. There is no need to transmit only licenses between entities like a server 2902 and the player 2903 or vice versa.

To exercise rights to use the protected content on the disk 2801:
1. The user places the disk 2801 into the player 2903 and requests exercise of a right.
2. The player 2903 interprets usage rules stored on the disk 2801. All information governing the use and distribution of protected content can be explicitly specified in the TUFs or MNGCOPY_LICENSES.XML file.
3. Depending on the usage rules on the disk 2801 and the right being exercised, the player 2903 may communicate with a content server 2901, an authorization server 2902, or both. If the player 2903 needs to obtain additional protected content or TUFs 2803, it contacts the content server 2901. The content server 2901 sends the requested protected content or TUFs 2803 to the player 2903. Communication between the player 2903 and a content server 2901 takes place as described in the “Download, Streaming, and Online Enabling” section of the AACS HD DVD and DVD Pre-recorded Book. If the player 2903 needs to obtain online authorization, it contacts the authorization server 2902. The authorization server 2902 determines the appropriate authorization response and sends it to the player 2903. Communication between the player 2903 and an authorization server 2902 takes place as described in the exemplary Protocol Book.
4. If the requested right is authorized, the player 2903 performs the requested exercise.

Usage rules can be associated with protected content in one of the following ways:

Copy-related usage rules are associated with a ResourceGroup

Other usage rules are associated with EVOBS and Playlists.

Usage rules need not be separately signed, but can be integrity protected as part of the AACS packaged content. The issuer of usage rules is the content provider. The key for the integrity of the usage rules belongs to AACS LA.

This section describes architectural scenarios illustrating exercise of the various rights supported by the exemplary embodiments.

When a user wants to play the protected content encoded on the disk 2801, the player 2903 interprets the usage rules associated with the protected content 2803 to determine whether the Play right is authorized. Exercise of the right may be authorized in one of the following ways:

The Play right is authorized by the usage rules encoded on the disk 2801.

The Play right is contingent upon authorization by an authorization server 2902, and the player 2903 requests the required authorization. The authorization server 2902 determines the appropriate response (which may involve interpreting usage rules 2807 stored on the server 2902 and/or making payments) and sends that response to the player 2903.

The requested Play operation requires additional protected content or additional TUFs, and the player 2903 requests the required content from the content server 2901. The content server 2901 sends the requested protected content or TUFs 2803 to the player 2903. If appropriate, the player 2903 may interpret additional usage rules included in TUFs received from the content server 2901 to determine whether the Play right is authorized.

If the Play right is authorized, the player plays the protected content.

Use of a managed copy is determined by the AACS specifications and compliance rules, and the rules can be fixed across all content types.

The following is assumed about the AACS Managed Copy function:

The intent of Managed Copy is for a DRM system to receive a version of the content from the disk 2801 that is then governed by the DRM system.

AACS compliance rules determine the usage of a Managed Copy, and it is assumed that the compliance rules allow the DRM system to play the Managed Copy indefinitely, but the compliance rules may preclude the Managed Copy from being indiscriminately retransmitted to other systems.

Furthermore, it is assumed that each disk 2801 must make an offer available for some pricing terms and conditions that allow a compliant AACS system to make a Managed Copy to one of the AACS approved DRM systems.

When a user wants to make a managed copy of the protected content 2803 encoded on the disk 2801, the player 2903 interprets the usage rules associated with the protected content 2803 to determine whether the Managed Copy right is authorized. Exercise of the right may be authorized in the following way:

The Managed Copy right is authorized by the usage rules encoded on the disk 2801. The exemplary usage rules can be used to authorize exercise of the Managed Copy right without connecting to the authorization server 2902.

The Managed Copy right is contingent upon authorization by an authorization server 2902, and the player 2903 requests the required authorization. The authorization server 2902 determines the appropriate response (which may involve interpreting usage rules 2807 stored on the server 2902 and/or making payments) and sends that response to the player 2903.

If the Managed Copy right is authorized, the player 2903 creates a copy of the protected content 2803 and associates new usage rules with it as specified in the AACS specifications and compliance rules.

The Advanced Copy right is the exemplary version of a copy. In the case of exercising the Managed Copy right, the use of a copy is determined by the AACS specifications and compliance rules, and the rules can be fixed across all content types. In the case of exercising the Advanced Copy right, use of the copy is governed by usage rules that are flexible and can vary on a title-by-title basis. The usage rules can be very sophisticated and include many parameters, including such things as fees, geographical restrictions, memberships, target DRM systems, dates, resolutions, tracking, and the like.

When a user wants to make an advanced copy of the protected content 2803 encoded on the disk 2801, the player 2903 interprets the usage rules associated with the protected content 2803 to determine whether the Advanced Copy right is authorized. Exercise of the right may be authorized in one of the following ways:

The Advanced Copy right is authorized by the usage rules encoded on the disk 2801.

The Advanced Copy right is contingent upon authorization by an authorization server 2902, and the player 2903 requests the required authorization. The authorization server 2902 determines the appropriate response (which may involve interpreting usage rules 2807 stored on the server 2902 and/or making payments) and sends that response to the player 2903.

If the Advanced Copy right is authorized, the player 2903 creates a copy of the protected content 2803 and the specified usage rules.

When a user wants to make a clear copy of the protected content 2803 encoded on the disk 2801, the player 2903 interprets the usage rules associated with the protected content 2803 to determine whether the Clear Copy right is authorized. Exercise of the right may be authorized in one of the following ways:

The Clear Copy right is authorized by the usage rules encoded on the disk 2801.

The Clear Copy right is contingent upon authorization by an authorization server 2902, and the player 2903 requests the required authorization. The authorization server 2902 determines the appropriate response (which may involve interpreting usage rules 2807 stored on the server 2902 and/or making payments) and sends that response to the player 2903.

If the Clear Copy right is authorized, the player 2903 creates a clear copy 2804 of the protected content 2803. The clear content 2804 is presumed to be either inherently protected by some other means (such as game copy protection) or released into a clear format (such as mp3, jpg, and the like).

When a user wants to expand their rights in an authorized manner (for example, binding certain rights to a certain player 2903), the player 2903 interprets the usage rules associated with the protected content 2803 to determine whether the Issue right is authorized. Exercise of the right may be authorized in one of the following ways:

The Issue right is authorized by the usage rules encoded on the disk 2801.

The Issue right is contingent upon authorization by an authorization server 2902, and the player 2903 requests the required authorization. The authorization server 2902 determines the appropriate response (which may involve interpreting usage rules 2807 stored on the server 2902 and/or making payments) and sends that response to the player 2903.

If the Issue right is authorized, the player 2903 creates the new rights for use in other authorizations.

When a user wants to play an advanced copy of the protected content 2803, the player 2903 interprets the usage rules associated with the copy to determine whether the Play Advanced Copy Content right is authorized. Exercise of the right may be authorized in one of the following ways:

The Play Advanced Copy Content right is authorized by the usage rules associated with the copy.

The Play Advanced Copy Content right is contingent upon authorization by an authorization server 2902, and the player requests the required authorization. The authorization server 2902 determines the appropriate response (which may involve interpreting usage rules 2807 stored on the server 2902 and/or making payments) and sends that response to the player 2903.

The requested Play Advanced Copy Content operation requires additional protected content or additional TUFs 2803, and the player 2903 requests the required content from the content server 2901. The content server 2901 sends the requested protected content or TUFs 2803 to the player 2903. If appropriate, the player 2903 may interpret additional usage rules included in TUFs received from the content server 2902 to determine whether the Play Advanced Copy Content right is authorized.

If the Play Advanced Copy Content right is authorized, the player 2903 plays the copy.

Further exemplary embodiments include determining the list of compliant advanced copy destinations, determining the list of compliant geographic determination technologies and the process/robustness criteria for approving such technologies, determining the list of compliant time determination technologies and the process/robustness criteria for approving such technologies, designating the authority who determines whether usage rules are not being respected and, if such authority is not AACS LA itself, remedy process to get AACS LA to revoke the offending devices, and the like.

The above-described devices and subsystems of the exemplary embodiments can include, for example, any suitable servers, workstations, PCs, laptop computers, PDAs, Internet appliances, handheld devices, cellular telephones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method for a digital content player having a DRM agent to perform rights management operations on a digital content package, said method comprising:
receiving, by said digital content player, rights management instructions to be executed by said digital content player, the rights management instructions being associated with said digital content package;
executing, by said digital content player, the rights management instructions, the rights management instructions requesting rights management operations and the rights management operations include issuing rights to content; and
loading supporting licenses associated with the digital content package for processing by said DRM agent;
said DRM agent determining whether to permit said rights management operations requested by the rights management instructions, according to said supporting licenses.

2. The method of claim 1, further comprising:
receiving, by said digital content player, from said digital content package, instructions for presenting a graphical user interface, said graphical user interface being adapted to present an option to said user and to receive input from said user regarding said option, said option being a rights management option suggested for use in accordance with said supporting licenses.

3. The method of claim 1, wherein said right management instructions include instructions for issuing a previously unissued license associated with said digital content package.

4. The method of claim 3, wherein said instructions for issuing another license include passing a URL where said other license resides.

5. The method of claim 1, wherein at least some of said rights management instructions are transmitted to said digital content player over a network.

6. The method of claim 1, wherein at least a portion of said digital content package is transmitted to said digital content player over a network.

7. The method of claim 1, wherein at least some of said supporting licenses are transmitted to said digital content player over a network.

8. The method of claim 2, wherein at least a portion of said digital content package is transmitted to said digital content player over a network.

9. The method of claim 2, wherein at least some of said supporting licenses are transmitted to said digital content player over a network.

10. An information recording medium to be played on a digital content player having a DRM agent to perform rights management operations on a digital content package, said recording medium comprising:
at least a portion of digital content package;
rights management instructions to be executed by said digital content player, the rights management instructions being associated with the digital content package and requesting rights management operations, the rights management operations include issuing rights to content; and
information identifying supporting licenses associated with the digital content package for processing by the DRM agent for enabling said DRM agent to determine whether to permit the rights management operations requested by the rights management instructions.

11. The information recording medium of claim 10, further comprising:
instructions for presenting a graphical user interface for presenting an option to said user and receiving input from said user regarding said option, said option being a rights management option suggested for use in accordance with said supporting licenses.

12. The information recording medium of claim 10, further comprising:
previously unissued licenses; and
wherein said right management instructions include instructions for issuing said previously unissued licenses.

13. The information recording medium of claim 12, wherein said instructions for issuing other licenses includes passing URLs where said other licenses reside.

14. The information recording medium of claim 10, wherein at least some of said rights management instructions are transmitted to said digital content player over a network.

15. An a digital content player having a DRM agent to perform rights management operations on a digital content package, the digital content player comprising:
one or more processors; and
one or more memories operatively coupled to at least one of the one or more processors and storing insstrucions which, when executed by at least one of the one or more processors, cause the at lease one of the one or more processors to:
receive rights management instructions to be executed by said digital content player, the rights management instructions being associated with said digital content package;
execute the rights management instructions, the rights management instructions requesting rights management operations and the rights management operations include issuing rights to content; and
load supporting licenses associated with the digital content package for processing by said DRM agent;
wherein said DRM agent determines whether to permit said rights management operations requested by the rights management instructions, according to said supporting licenses.
